(19) United States
(12) Patent Application Publication
(10) Pub. No.: US 2026/0323565 A1
(43) Pub. Date: Oct. 15, 2026

(54) METHOD AND DEVICE FOR PROVIDING SERVICE BY USING ULTRA-WIDE BAND COMMUNICATION

(71) Applicant: SAMSUNG ELECTRONICS CO., LTD., Suwon-si, Gyeonggi-do (KR)

(72) Inventors: Jonghoe KOO, Suwon-si (KR); Kookheui LEE, Suwon-si (KR); Youngwan SO, Suwon-si (KR)

(21) Appl. No.: 18/992,877

(22) PCT Filed: Jul. 11, 2023
(86) PCT No.: PCT/KR2023/009892

§ 371 Date: Jan. 9, 2025

(30) Foreign Application Priority Data
Jul. 11, 2022 (KR) 10-2022-0085319

(51) Int. Cl. H04W 64/00; H04B 1/7163; H04W 4/24

(52) U.S. Cl. CPC H04W 64/00; H04B 1/7163; H04W 4/24

(57) ABSTRACT

The present disclosure discloses a method for providing a service by using UWB communication. A method for a UWB device may comprise the steps of: receiving, from an initiator anchor, a first UWB message initiating a ranging procedure; receiving, from a plurality of responder anchors, a plurality of second UWB messages transmitted in response to the first UWB message; receiving, from the initiator anchor, a third UWB message transmitted in response to the second UWB messages; and performing DL-TDoA-based localization on the basis of the first UWB message, the second UWB messages, and the third UWB message.

### CROSS-REFERENCE TO RELATED APPLICATIONS

This application is a National Phase Entry of PCT international Application No. PCT/KR2023/009892, which was filed on Jul. 11, 2023, and claims priority to Korean Priority Patent Application No. 10-2022-0085319 filed on Jul. 11, 2022, in the Korean National Intellectual Property Administration, the contents of which are incorporated herein by reference.

### BACKGROUND

### 1. Field

The disclosure relates to UWB communication and, more specifically, to a method and a device for providing a service by using UWB communication.

### 2. Description of Related Art

The Internet, a human centered connectivity network where humans generate and consume information, is now evolving to the Internet of things (IoT) network where distributed entities, such as things, exchange and process information. The Internet of everything (IoE) technology, which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, technology such as a sensor network, machine-to-machine (M2M) communication, machine type communication (MTC), and so forth is being researched.

Such an IoT environment may provide intelligent Internet technology (IT) services that create new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

With the advance of wireless communication systems as described above, various services can be provided, and accordingly there is a need for ways to effectively provide these services. For example, a ranging technology for measuring the distance between electronic devices by using an ultrawide band (UWB) may be used.

### SUMMARY

The disclosure provides a method for providing a service (e.g., a payment service) by using UWB communication.

A method of a UWB device according to an embodiment of the disclosure may include: receiving, from an initiator anchor, a first UWB message for initiating a ranging procedure; receiving, from multiple responder anchors, multiple second UWB messages transmitted in response to the first UWB message; receiving, from the initiator anchor, a third UWB message transmitted in response to the second UWB messages; and based on the first UWB message, the second UWB messages, and the third UWB message, performing DL-TDoA-based localization.

A UWB device according to an embodiment of the disclosure may include: a transceiver; and a controller connected to the transceiver, wherein the controller is configured to: receive, from an initiator anchor, a first UWB message for initiating a ranging procedure; receive, from multiple responder anchors, multiple second UWB messages transmitted in response to the first UWB message; receive, from the initiator anchor, a third UWB message transmitted in response to the second UWB messages; and based on the first UWB message, the second UWB messages, and the third UWB message, perform DL-TDoA-based localization.

The disclosure can efficiently provide a service (e.g., a payment service) by using UWB communication.

### BRIEF DESCRIPTION OF THE DRAWINGS

FIG. 1 illustrates an example architecture of a UWB device according to an embodiment of the disclosure.

FIG. 2A illustrates an example configuration of a communication system including electronic devices supporting a UWB-based service according to an embodiment of the disclosure.

FIG. 2B illustrates an example configuration of a communication system including electronic devices supporting a UWB-based payment service according to an embodiment of the disclosure.

FIG. 3 illustrates an example configuration of a framework included in an electronic device supporting a UWB-based service according to an embodiment of the disclosure.

FIG. 4 illustrates a structure of a UWB MAC frame according to an embodiment of the disclosure.

FIG. 5 illustrates a structure of a UWB PHY packet according to an embodiment of the disclosure.

FIG. 6A illustrates an example of a ranging block structure according to an embodiment of the disclosure.

FIG. 6B illustrates an example of a ranging round according to an embodiment of the disclosure.

FIG. 7 illustrates various examples of a UWB ranging method according to an embodiment of the disclosure.

FIG. 8A illustrates a method of performing UWB ranging in a DL-TDoA scheme by a UWB device according to an embodiment of the disclosure.

FIG. 8B illustrates an example of a ranging block structure for a downlink TDoA scheme according to an embodiment of the disclosure.

FIG. 9 illustrates a payment processing method using UWB according to an embodiment of the disclosure.

FIG. 10 illustrates a method of performing both DL-TDoA ranging and contention-based ranging by a UWB device according to an embodiment of the disclosure.

FIG. 11 illustrates a method of performing both DL-TDoA ranging and contention-based ranging by a UWB device according to an embodiment of the disclosure.

FIG. 12A illustrates a structure of a UWB message according to an embodiment of the disclosure.

FIG. 12B illustrates a payload structure of the UWB message according to an embodiment of the disclosure.

FIG. 12C illustrates a payload structure of a UWB message according to an embodiment of the disclosure.

FIG. 13A illustrates an example of an OWR message type-dependent payload field included in a UWB message, according to an embodiment of the disclosure.

FIG. 13B illustrates an example of an OWR message type-dependent payload field included in a UWB message, according to an embodiment of the disclosure.

FIG. 14 illustrates a method of generating a secure channel according to an embodiment of the disclosure.

FIG. 15 illustrates a UWB device including a secure component according to an embodiment of the disclosure.

FIG. 16 illustrates a UWB device including a secure component according to an embodiment of the disclosure.

FIG. 17 illustrates a method of transferring data in a secure component of a UWB device to a UWBS according to an embodiment of the disclosure.

FIG. 18 illustrates APDU types supported in an SUS API according to an embodiment of the disclosure.

FIG. 19A illustrates a data transmission procedure using UWB according to an embodiment of the disclosure.

FIG. 19B is a diagram illustrating an embodiment of exchanging data while performing contention-based ranging between a first UWB device and multiple second UWB devices.

FIG. 19C is a diagram illustrating an embodiment of exchanging data while performing contention-based ranging between the first UWB device and the multiple second UWB devices.

FIG. 19D is a diagram illustrating an embodiment of exchanging data while performing contention-based ranging between the first UWB device and the multiple second UWB devices.

FIG. 20A illustrates a UWB message for data transmission according to an embodiment of the disclosure.

FIG. 20B illustrates an example of a content field of the UWB message for data transmission according to an embodiment of the disclosure.

FIG. 20C illustrates an example of a content field of the UWB message for data transmission according to an embodiment of the disclosure.

FIG. 21 illustrates a structure of a first UWB device according to an embodiment of the disclosure.

FIG. 22 illustrates a structure of a second UWB device according to an embodiment of the disclosure.

FIG. 23 illustrates an example of a data message payload IE according to an embodiment of the disclosure.

### DETAILED DESCRIPTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various example of the terminal may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and reproduction home appliance having a wireless communication function, an Internet home appliance capable of wireless Internet access and browsing, and portable units or terminals having integrated combinations of the above functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using UWB will be described by way of example, but the embodiments of the disclosure may be applied to other communication systems having similar technical backgrounds or characteristics. Examples of such communication systems may include communication systems Bluetooth or ZigBee. Therefore, based on determinations by those skilled in the art, the embodiments of the disclosure may be applied to other communication systems through some modifications without significantly departing from the scope of the disclosure.

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technologies is largely divided into a wireless local area network (WLAN) technology and a wireless personal area network (WPAN) technology according to a recognition distance. In this case, a wireless LAN is a technology based on IEEE 802.11, and is a technology enabling access to a backbone network within a radius of about 100 m. A wireless personal area network is a technology based on IEEE 802.15, and includes Bluetooth, ZigBee, ultra-wide band (UWB), etc. A wireless network in which the wireless network technologies are implemented may include multiple electronic devices.

According to a definition by the federal communications commission (FCC), UWB may refer to a wireless communication technology in which a bandwidth of 500 MHz or higher is used, or a bandwidth corresponding to a center frequency is 20% or greater. UWB may refer to a band itself to which UWB communication is applied. UWB may enable secure and accurate ranging between devices. Based on this, UWB enables relative position estimation based on the distance between two devices or accurate position estimation of a device based on the distance from fixed devices (whose positions are known).

Specific terms used in the following descriptions are provided to aid understanding of the disclosure, and the use of these specific terms may be changed in other forms without departing from the technical spirit of the disclosure.

“Application dedicated file (ADF)” may be, for example, a data structure in an application data structure that may host an application or application-specific data.

“Application protocol data unit (APDU)” may be a command and a response used when communicating with an application data structure in a UWB device.

“Application-specific data” may be, for example, a file structure having a root level and an application level including UWB controlee information and UWB session data required for a UWB session.

“Controller” may be a ranging device that defines and controls ranging control messages (RCMs) or control messages. The controller may define and control ranging features by transmitting a control message.

“Controlee” may be a ranging device using a ranging parameter in an RCM (or a control message) received from a controller. The controlee may use the same ranging features as those configured a via control messages from the controller.

Unlike “static STS,” “dynamic scrambled timestamp sequence (STS) mode” may be an operation mode in which an STS is not repeated during a ranging session. In this mode, the STS may be managed by the ranging device, and a ranging session key for generating the STS may be managed by a secure component.

“Applet” may be, for example, an applet executed on a secure component including UWB parameters and service data. The applet may be a FiRa applet.

“Ranging device” may be a device capable of performing UWB ranging. In the disclosure, the ranging device may be a FiRa device or an enhanced ranging device (ERDEV) defined in IEEE 802.15.4z. The ranging device may be referred to as a UWB device.

“UWB-enabled application” may be an application for a UWB service. For example, the UWB-enabled application may be an application using a framework API for configuring an out-of-band (OOB) connector, a secure service, and/or a UWB service for a UWB session. “UWB-enabled application” may be abbreviated as application or UWB application. The UWB-enabled application may be a FiRa-enabled application.

“Framework” may be a component that provides access to a profile, an individual-UWB configuration, and/or a notification. The framework may be, for example, a collection of logical software components including a profile manager, an OOB connector, a secure service, and/or a UWB service. The framework may be a FiRa framework.

“OOB connector” may be a software component for establishing an out-of-band (OOB) connection, (e.g., BLE connection) between ranging devices. The OOB connector may be a FiRa OOB connector.

“Profile” may be a previously defined set of UWB and OOB configuration parameters. The profile may be a FiRa profile.

“Profile manager” may be a software component that implements a profile available on a ranging device. The profile manager may be a FiRa profile manager.

“Service” may be implementation of a use case that provides a service to an end-user.

“Smart ranging device” may be a ranging device that may implement an optional framework API. The Smart ranging device may be a FiRa smart device.

“Global dedicated file (GDF)” may be a root level of application-specific data including data required to establish a USB session.

“Framework API” may be an API used by a UWB-enabled application to communicate with a framework.

“Initiator” may be a ranging device that initiates a ranging exchange. The initiator may initiate a ranging exchange by transmitting a first RFRAME (ranging exchange message).

“Object identifier (OID)” may be an identifier of an ADF in an application data structure.

“Out-Of-Band (OOB)” may be data communication that does not use UWB as an underlying radio technology.

“Ranging data set (RDS)” may be data (e.g., a UWB session key, a session ID, etc.) required to establish a UWB session where confidentiality, authenticity, and integrity need to be protected.

“Responder” may be a ranging device that responds to an initiator in a ranging exchange. The responder may respond to a ranging exchange message received from the initiator.

“STS” may be a ciphered sequence for increasing the integrity and accuracy of ranging measurement timestamps. The STS may be generated from a ranging session key.

“Secure channel” may be a data channel that prevents overhearing and tampering.

“Secure component” may be an entity (e.g., a secure element (SE) or a trusted execution environment (TEE)) having a defined security level that interfaces with a UWBS for the purpose of providing an RDS to the UWBS, for example, when a dynamic STS is used.

“SE” may be a tamper-resistant secure hardware component that may be used as a secure component in a ranging device.

“Secure ranging” may be ranging based on an STS generated via a strong encryption operation.

“Secure service” may be a software component for interfacing with a secure component, such as a secure element or a TEE.

“Service applet” may be an applet on a secure component that handles a service-specific transaction.

“Service data” may be data defined by a service provider that needs to be transferred between two ranging devices in order to implement a service.

“Service provider” may be an entity that defines and provides hardware and software required to provide a specific service to an end-user.

“Static STS mode” is an operation mode in which an STS is repeated during a session, and does not need to be managed by a secure component.

“Secure UWB service (SUS) applet” may be an applet on an SE that communicates with an applet to retrieve data required to enable a secure UWB session with another ranging device. In addition, the SUS applet may transfer corresponding data (information) to a UWBS.

“UWB service” may be a software component that provides access to a UWBS.

“UWB session” may be a period from a time when a controller and a controlee start communication via UWB to a time when the communication stops. The UWB session may include ranging, data transfer, or both ranging and data transfer.

“UWB session ID” may be an ID (e.g., a 32-bit integer) for identification of a UWB session, which is shared between a controller and a controlee.

“UWB session key” may be a key used to protect a UWB session. The UWB session key may be used to generate an STS. The UWB session key may be a UWB ranging session key (URSK), and may be abbreviated as session key.

“UWB subsystem (UWBS)” may be a hardware component implementing UWB PHY and MAC layers (specifications). The UWBS may have an interface to a framework and an interface to a secure component to search for an RDS.

“UWB message” may be a message including a payload information element (IE) transmitted by a UWB device (e.g., an ERDEV).

“Payload IE” may be an IE included in a MAC payload of a UWB MAC frame. The MAC payload may include one or more payload IEs.

“Scheduling-based ranging (scheduled-based ranging)” may be used for a ranging round scheduled by a controller for controlees to transmit ranging frames (RFRAMEs) and/or measurement reports in different ranging slots. Scheduling-based ranging may be referred to as time-scheduled ranging. A scheduling mode in which scheduling-based ranging is used may be referred to as a time-scheduled mode.

“Contention-based ranging” may be used when a controller has no knowledge about MAC addresses of controlees participating in a UWB session (ranging session). In contention-based ranging, a controller may be an initiator and may perform ranging with another unknown UWB device. The scheduling mode in which contention-based ranging is used may be referred to as a contention-based mode.

Contention-based ranging may be used for a ranging round in which a controller determines a size of a contention access period (CAP) and indicates the size of the CAP via a ranging control message. The CAP may be referred to as a contention window or a contention window period.

In the contention-based mode, a UWB device may operate as a controller and an initiator, and in this case, a ranging control phase (RCP) and a ranging initiation phase (RIP) may be merged into one phase (e.g., RIP). In the ranging phase (RP), CAP size allocation may determine a CAP period for a responder(s) participating in the corresponding ranging round in units of ranging slots. Each responder may randomly determine one slot in a CAP to transmit a ranging response message (RRM). Messages used in contention-based ranging may use SP1 as an RFRAME configuration.

“Hybrid ranging” may be used when there are a known controlee and an unknown controlee. As described above, a known controlee may be a controlee having a MAC address thereof known to a controller, and an unknown controlee may be a controlee having a MAC address thereof unknown to a controller. Hybrid ranging may be referred to as hybrid-based ranging. A scheduling mode in which hybrid ranging is used may be referred to as a hybrid-based mode.

In the hybrid-based mode, a controller may perform ranging with a known controlee in a scheduling-based mode and perform ranging with an unknown controlee in a contention-based mode.

In the hybrid-based mode, ranging round may include a ranging control phase (RCP) and a ranging phase (RP). The RP may include a contention free period for scheduling-based ranging (access) and a contention access period (CAP) for contention-based ranging (access). A control message (ranging control message) used in the RCP of the hybrid-based mode may be referred to as a ranging management message (RMM).

“Downlink time difference of arrival (DL-TDoA, DT)” may be a positioning method for one or more tag devices (DT-Tag) to estimate positions thereof based on a DL-TDoA message (DTM) received from at least one anchor device (DT-anchor). In the DL-TDoA, the anchor device may transmit or broadcast the DTM, and the tag device may passively receive the DTM, thereby preventing exposure of the position of the tag device.

In the DL-TDoA, the anchor device may precisely measure its own DTM transmission time and a reception time of the received DTM. The anchor device may include the transmission time in the transmitted or broadcast DTM. The tag device may measure reception times of all received DTMs and estimate a position of the tag device itself by using reception timestamps and acquired coordinates of the anchor devices. DL-TDoA may be classified as a type of one way ranging like uplink TDoA. DL-TDoA may be referred to as DL-TDoA localization.

“Anchor device” may be a UWB device deployed at a specific position to provide a positioning service. For example, the anchor device may be a UWB device that a service provider installs on a wall, ceiling, structure, or the like in a room in order to provide an indoor positioning service. In DL-TDoA, the anchor device may be a device that transmits a DTM that the tag device may use to calculate a position based on TDoA localization (DL-TDoA localization). In DL-TDoA, the anchor devices may be divided into an initiator anchor and a responder anchor according to roles and a sequence of transmitting messages, so as to participate in a ranging round. The anchor device may be referred to as a UWB anchor or a UWB anchor device, and the anchor device of DL-TDoA may be referred to as a DL-TDoA anchor or a DT-anchor.

“Initiator anchor” may notify of initiation of a TDoA ranging round (DL-TDoA ranging round). In DL-TDoA, the initiator anchor may initiate a DL-TDoA ranging round by transmitting an initiation message, and may schedule a transmission time of a responder anchor(s). For example, the initiator anchor may schedule a ranging slot in which the responder anchor(s) operating in the same ranging round transmits a response message (response DTM). The initiation message may be referred to as an initiator DTM, a poll message, a poll DTM, or a first DTM. The initiator anchor may be referred to as an initiator UWB anchor, an initiator anchor device, or an initiator DT-anchor.

The initiator anchor may additionally transfer an end message (final DTM) after receiving the response from the responder anchor(s). The initiator anchor may additionally transmit a final DTM after all responder anchors in the same cluster transmit response messages (response DTMs) in the DL-TDoA ranging round. The final message may be referred to as a final DTM or a third DTM.

There may be at least one reference initiator anchor in a DL-TDoA network. The reference initiator anchor is an initiator anchor serving as a global time reference for inter-cluster synchronization, and may configure a common ranging block structure for the DL-TDoA network to operate. The reference initiator anchor may be referred to as a master anchor or a global anchor.

“Responder anchor” may be a UWB anchor responding to an initiation message of an initiator anchor. The responder anchor may respond to the initiator anchor by using a response message. The response message may be referred to as a responder DTM, a response DTM, or a second DTM. The responder anchor may also be referred to as a responder UWB anchor, a responder UWB anchor device, a responder anchor device, etc.

“Tag device” may estimate a position thereof (e.g., geographical coordinates) by using TDoA measurement based on a DTM received from an anchor device in DL-TDoA. The tag device may identify a position of the anchor device in advance. The tag device may be referred to as a UWB tag, a UE, or a UWB tag device, and a DL-TDoA tag device may be referred to as a DL-TDoA tag or a DT-tag.

The tag device may receive the message transmitted by the anchor device and measure a reception time of the message. The tag device may acquire geographic coordinates of the anchor device via an in-band or out-band method. The tag device may skip a ranging block when a position update rate is lower than that supported by a network.

“Cluster” may refer to a set of anchor devices covering a specific area. In DL-TDoA, a cluster may refer to a set of anchor devices that exchange DTMs to provide a position service to at least one tag device. The cluster may include an initiator anchor and at least one responder anchor.

One anchor device may operate in one or more clusters. In this case, an anchor device operating as an initiator anchor in some clusters may operate as a responder anchor in other clusters. A cluster area may be a space configured by the anchor devices constituting the cluster. In order to support a positioning service for a wide area, multiple clusters may be configured to provide the positioning service to a UE. A cluster may be referred to as a cell.

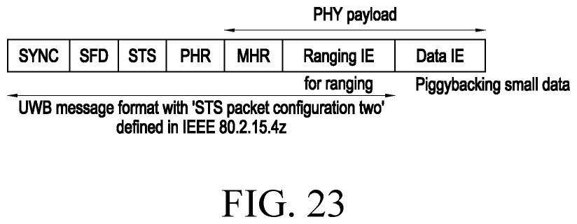

“Data message payload information element (DM payload IE)” may be a payload IE used to transmit data generated from an application, an applet, or other data sources by including the data in a UWB message. In the disclosure, the data message payload IE may also be simply referred to as a data message. The data message payload IE may be combined with a ranging payload IE as shown in FIG. 23 so as to be a part of a PHY payload of the UWB message.

The data message payload IE may include a vendor OUI, a UWB message identifier (UWB message ID), a data message type (DM type), and a content field, or include some thereof. The data message payload IE may be configured as shown in Table 1.

TABLE 1
Data Message Payload IE (DM payload IE) Format

| Parameter | Size (bits) | Notes |
|---|---|---|
| Vendor OUI | 24 | 0 × 5A18FF (FiRa OUI) |
| UWB | 4 | 0 × 8: DM (Data Message) |
| Message | | |
| ID | | |
| DM Type | 4 | Specifies the type of the Content field |
| | | 0 × 0: Payload |
| | | 0 × 1: Data Transfer Phase Control |
| | | Message (DTPCM) |
| | | 0 × 2 - 0 × F: RFU |
| Content | Variable | DM Type 0\| Payload (0 × 0) |
| | | [symbol] 2 [symbol] |
| | | DM Type 0\| DTPCM (0 × 1) |
| | | [symbol] 3 [symbol] |

Depending on a data message type, content of a message included in the content field may vary. If a value of the data message type (DM Type) field is 0x0, the content field may include general application data. The content field may additionally include a length of transferred application data. The content field may also include, as a payload, a MAC data service data unit (MDSDU) that is data generated in a layer higher than a MAC layer of a UWB subsystem and transmitted to a MAC. If the data message type (DM Type) is 0x0, the content field may be configured as shown in Table 2. If the DM type is Payload (0x0), follows the format of Table 2, and if the DM type is DTPCM (0x1), follows the format of Table 3.

TABLE 2
Content Field format for DM Type Payload

| | Size | |
|---|---|---|
| Parameter | (bits) | Notes |
| Payload | 16 | Size (N) in units of bytes followed in the |
| Size | | Payload field |
| Payload | N*8 | MDSDU (MAC Data Service Data Unit) |
| | | or part thereof |

If a value of the data message type (DM Type) field of the data message payload IE is 0x1, the content field may include a data transfer phase control message (DTPCM). A DTPCM content field may be configured as shown in Table 3 below, and a DTPML format may be configured as shown in Table 4 below. List including N components following the format of Table 4.

TABLE 3
Data Transfer Phase Control Message Content Field

| | Size | |
|---|---|---|
| Parameter | (bits) | Notes |
| Data | 8 | Bit 0: 0b0 subsequent DTPCM |
| Transfer | | 0b1 first DTPCM, starting data transfer |
| Control | | Bit 1: 0b0 MAC address length 16bits |
| | | 0b1 MAC address length 64bits |
| | | Bits 2 to 3: Slot Bitmap size |
| | | 00b00 : 8 ranging slots |
| | | 00b01 : 16 ranging slots |
| | | 00b10 : 32 ranging slots |
| | | 00b11: 64 ranging slots |
| | | Bits 4 to 7: RFU |
| DTPML | 8 | Encodes the size of one element |
| Element | | of the DTPML in bytes |
| Size | | |
| Data | 8 | Data Transfer Phase Management |
| Transfer | | List Length (N) |
| Phase | | Encodes the number N of elements |
| Management | | in the DTPML |
| List | | |
| (DTPML) | | |
| Length | | |
| Data | variable | Data Transfer Phase Management |
| Transfer | | Entries List. [symbol] 4 [symbol] |
| Phase | | [symbol] |
| Management | | [symbol] |
| List | | [symbol] . |
| (DTPML) | | |

TABLE 4
Data Transfer Phase Management List (DTPML) Format

| | Size | |
|---|---|---|
| Parameter | (bits) | Notes |
| MAC | 16/64 | MAC Address with size defined in Data |
| Address | | Transfer Control field. All parameter |
| | | fields apply to the FiRa Device assoc- |
| | | iated to this MAC address. |
| Slot | variable | Slot Bitmap. |
| Bitmap | | Each bit represents one slot index (e.g., |
| | | bit0 current ranging slot + 1 . . . bit 63 |
| | | current ranging slot + 64). |
| | | The Slot Bitmap size is encoded in bit |
| | | map size field, defined in the Data |
| | | Transfer Control field. |
| | | If a bit in the Slot Bitmap is set to the |
| | | value 0b1, then the FiRa Device with |
| | | the MAC address of this element may |
| | | send its DM in the ranging slot cor- |
| | | responding to this bit position. |
| Stop Data | 1 | 0b0: Data Transfer will be continued |
| Transfer | | 0b1: Data Transfer will be stopped |
| RFU | 7 | Reserved for Future Use |

In addition, in describing the disclosure, when it is determined that a detailed description of a related known function or configuration may unnecessarily obscure a subject matter of the disclosure, the detailed description thereof will be omitted.

Hereinafter, various embodiments of the disclosure are described with reference to the accompanying drawings.

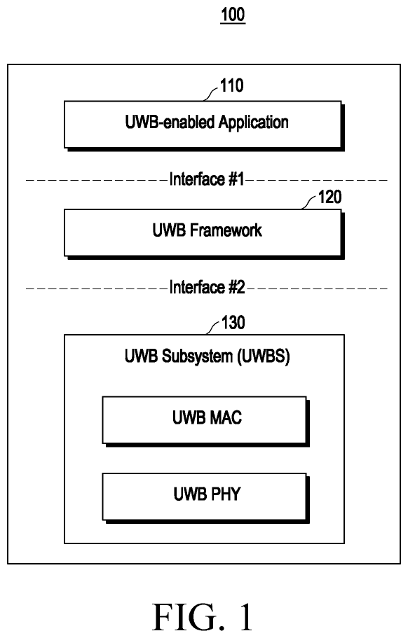

FIG. 1 illustrates an example architecture of a UWB device according to an embodiment of the disclosure.

A UWB device 100 may be an electronic device supporting UWB communication. The UWB device 100 may be, for example, a ranging device supporting UWB ranging. In an embodiment, the ranging device may be a FiRa device or an enhanced ranging device (ERDEV) defined in IEEE 802.15.4z.

In the embodiment of FIG. 1, the UWB device 100 may interact with another UWB device via a UWB session.

In addition, the UWB device 100 may implement a first interface (interface #1) that is an interface between a UWB-enabled application 110 and a framework 120, and the first interface allows the UWB-enabled application 110 on the UWB device 100 to use UWB capabilities of the UWB device 100 in a predetermined scheme. In an embodiment, the first interface may be a framework API or a proprietary interface, but is not limited thereto.

In addition, the UWB device 100 may implement a second interface (interface #2) that is an interface between the UWB framework 110 and a UWB subsystem (UWBS) 130. In an embodiment, the second interface may be a UWB command interface (UCI) or proprietary interface, but is not limited thereto.

Referring to FIG. 1, the UWB device 100 may include the UWB-enabled application 110, the framework (UWB framework) 120, and/or the UWBS 130 including a UWB MAC layer and a UWB physical layer. According to an embodiment, some entities may not be included in the UWB device, or additional entities (e.g., security layer) may be further included.

The UWB-enabled application 110 may trigger establishment of a UWB session by the UWBS 130 via the first interface. The UWB-enabled application 110 may use one of previously defined profiles. The UWB-enabled application 110 may use the first interface to handle related events, such as service discovery, ranging notifications, and/or error conditions.

The framework 120 may provide access to the profile, individual UWB configurations, and/or notifications. The framework 120 may support at least one of functions, such as a function for performing UWB ranging and transaction, a function for providing an interface to an application and the UWBS 130, or a position estimation function of the device 100. The framework 120 may be a set of software components. As described above, the UWB-enabled application 110 may interface with the framework 120 via the first interface, and the framework 120 may interface with the UWBS 130 via the second interface.

In the disclosure, the UWB-enabled application 110 and/or the framework 120 may be implemented by an application processor (AP) (or processor). Accordingly, in the disclosure, it may be understood that operations of the UWB-enabled application 110 and/or the framework 120 are performed by an AP (or processor). In the disclosure, the framework may be referred to as an AP or a processor.

The UWBS 130 may be a hardware component including the UWB MAC layer and the UWB physical layer. The UWBS 130 may perform UWB session management and communicate with a UWBS of another UWB device. The UWBS 130 may interface with the framework 120 via the second interface and may acquire secure data from a secure component. In an embodiment, the framework (or application processor) 120 may transmit a command to the UWBS 130 via UCI, and the UWBS 130 may transmit a response to the command to the framework 120. The UWBS 130 may transfer a notification to the framework 120 via the UCI.

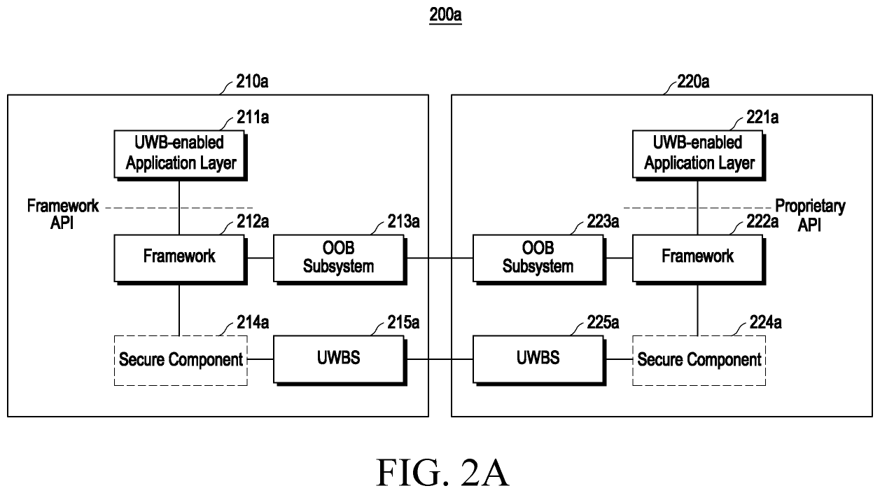

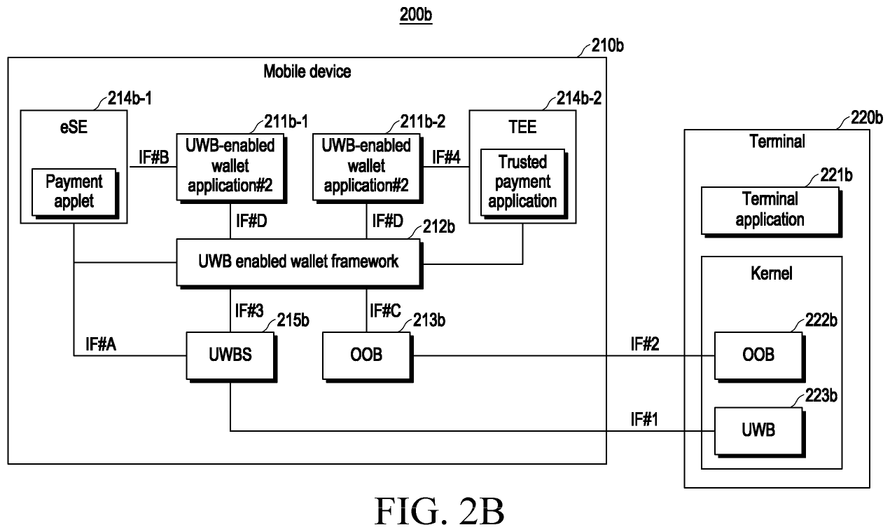

FIG. 2A illustrates an example configuration of a communication system including electronic devices supporting a UWB-based service according to an embodiment of the disclosure.

Referring to FIG. 2A, a communication system 200 includes a first electronic device 210a and a second electronic device 220a.

As an embodiment, the first electronic device 210a and the second electronic device 220a may be, for example, the UWB device of FIG. 1 or an electronic device including the UWB device of FIG. 1. For example, the first electronic device 210a may be, for example, a smart ranging device or a ranging device, and the second electronic device 220a may be, for example, a smart ranging device or a ranging device. As an embodiment, the smart ranging device or the ranging device may be a FiRa device or an enhanced ranging device (ERDEV) defined in IEEE 802.15.4z. In FIG. 2A, the first electronic device may be referred to as a first UWB device, and the second electronic device may be referred to as a second UWB device.

The first electronic device 210a may, for example, host one or more UWB-enabled applications which may be installed by a user (e.g., a mobile phone). This may be based on a framework API. The second electronic device 220a may provide no framework API and use, for example, a proprietary interface to implement a specific UWB-enabled application provided only by a manufacturer. Unlike what is illustrated, depending on an embodiment, both the first UWB device and the second UWB device may be ranging devices using the framework API, or both the first UWB device and the second UWB device may be ranging devices using the proprietary interface.

The first electronic device 210a and the second electronic device 220a may include UWB-enabled application layers (UWB-enabled applications) 211a and 221a, frameworks 212a and 222a, OOB components (OOB subsystems) 213a and 223a, secure components 214a and 224a, and/or UWBSs 215a and 225a, respectively. Depending on an embodiment, some components may be omitted or an additional component may be included.

The first electronic device 210a and the second electronic device 220a may generate an OOB connection (channel) via the OOB components 213a and 223a and generate a UWB connection (channel) via the UWBSs 215a and 225a, thereby communicating with each other.

The frameworks 212a and 222a may serve to provide access to profiles, individual UWB configurations, and/or notifications. The frameworks 212a and 222a are sets of software components and each set may include, for example, a profile manager, an OOB connector, a secure service, and/or a UWB service.

The OOB components 213a and 223a may be hardware components including a MAC layer and/or a physical layer for OOB communication (e.g., BLE communication). The OOB components 213a and 223a may communicate with an OOB component of another device. In an embodiment, the first UWB device 210a and the second UWB device 220a may generate the OOB connection (channel) by using the OOB component 213a and 223a, and exchange parameters for establishing a UWB session via the OOB channel. In the disclosure, the OOB component 213a and 223a may be referred to as OOB subsystems.

The secure components 214a and 224a may be hardware components that interface with the framework and/or the UWBS to provide an RDS. In an embodiment, the secure components 214a and 224a may be SEs (e.g., eSEs), TEEs (or trusted applications (TAs) within the TEEs), or strongboxes (SBs).

The UWBSs 215a and 225a may be hardware components including the UWB MAC layer and the UWB physical layer. The UWBSs 215a and 225a may perform UWB session management and communicate with a UWBS of another UWB device. In an embodiment, the first UWB device 210a and the second UWB device 220a may perform UWB ranging and service data transaction via the UWB session established via the UWBSs 215a and 225a by using the parameters exchanged with each other.

In the disclosure, the UWB-enabled application layers and/or the frameworks may be implemented by an application processor (AP) (or processor). Accordingly, in the disclosure, it may be understood that operations of the UWB-enabled applications and/or the frameworks are performed by an AP (or processor).

FIG. 2B illustrates an example configuration of the communication system including electronic devices supporting a UWB-based service according to an embodiment of the disclosure.

The embodiment of FIG. 2B may be an example of the embodiment of FIG. 2A.

In the embodiment of FIG. 2B, a UWB-based service may be a UWB-based payment service (wallet service). In the disclosure, embodiments of the disclosure are described assuming that the UWB-based service is a UWB-based payment service, but the embodiments of the disclosure may also be applied to other types of UWB-based services.

Referring to FIG. 2B, a communication system 200b that provides a UWB-based payment service may include a first electronic device 210b and a second electronic device 220b. In FIG. 2B, the first electronic device may be referred to as a first UWB device, and the second electronic device may be referred to as a second UWB device.

<First Electronic Device 210b>

The first electronic device 210b may be an electronic device of a user (e.g., a mobile device of a user) for a UWB-based payment service. The first electronic device 210b may include at least one UWB-enabled wallet application (UWB-enabled application) 211b-1 and 211b-2, a UWB-enabled wallet framework 212b, an OOB component 213b, at least one secure component 214b-1 and 214b-2, and/or a UWBS 215b. For a description of each component, reference may be made to the description of FIG. 2A.

In the embodiment of FIG. 2B, for convenience of description, it is described that a UWB-enabled application corresponds to the UWB-enabled wallet application, and a framework corresponds to the UWB-enabled wallet framework, but the embodiment is not limited thereto, and various UWB-enabled applications and frameworks may be implemented to provide various types of UWB-based services. In FIG. 2B, the UWB-enabled wallet application may be referred to as a UWB-enabled application, a UWB-enabled payment application, etc., and the UWB-enabled wallet framework may be referred to as a UWB-enabled payment framework, a framework, etc.
(1) The UWB-enabled applications 211b-1 and 211b-2 may support at least one of the following features.
   Hosting an applet (payment applet) for UWB-based payment within an SE (e.g., an embedded SE (eSE)) or a trusted application (trusted payment application) for UWB-based payment within a TEE
   When requested by the framework, providing a UWB block structure (e.g., a ranging block structure) and/or placement information of anchors for position estimation of the first electronic device
   Communicating with the second electronic device and a back-end server for personalization of the payment applet or the trusted payment application (TPA)
(2) The framework 212b may support at least one of the following features.
   Estimating a position of the first electronic device
   Implementing UCI commands
   Providing a set of APIs for the UWB-enabled application to access the UWBS and the OOB component
(3) The OOB component 213b may support the following features.
   Implementing an OOB connection operation (e.g., a BLE connection operation)
(4) The trusted payment application 211b-2 may be included in the TEE and may support at least one of the following features.
   Supporting a TEE client API
   Implementing the trusted application
   Implementing a secure channel protocol to communicate with the second electronic device in a secure manner
   Hosting payment credentials and cryptographic keys for a secure channel
   Hosting important information (e.g., card information) to support a UWB-based payment service
(5) The payment application 211b-1 may be included in the SE (eSE) and may support at least one of the following features.
   Supporting an APDU
   Implementing a secure channel protocol to communicate with the second electronic device in a secure manner
   Hosting payment credentials and cryptographic keys for a secure channel
   Hosting important information (e.g., card information) to support a UWB-based payment service

Each component of the first electronic device 210b may communicate with another component via a predefined interface (IF). Hereinafter, each interface is described.
IF #1: An interface between the UWBS 215b of the first electronic device 210b and the UWBS of another electronic device (e.g., the UWBS 223b of the second electronic device 220b). IF #1 may be used to exchange a UWB message and/or a payment transaction.
IF #2: An interface between the OOB component 213b of the first electronic device 210b and the OOB component of another electronic device (e.g., the OOB component 222b of the second electronic device 220b). IF #2 may be used to exchange an OOB message.
IF #3: An interface between the framework 212b and the UWBS 215b. IF #3 may be used to exchange a UCI message. For example, IF #3 may be used to exchange a UCI message (e.g., a UCI command/UCI notification, etc.) for establishing a secure channel between the trusted payment application 211b-2 and the UWBS 215b.
IF #4: An interface between the UWB-enabled application 211b-2 and the trusted payment application 211b-2 within the TEE. IF #4 may be used to exchange TEE commands via the TEE client API. For example, IF #4 may be used to exchange TEE Commands for establishing a secure channel between the trusted payment application 211b-2 and the UWBS 215b.
IF #A: An interface between the UWBS 215b and the UWB-enabled applications 211b-1 and 211b-2. IF #A may be, for example, an SUS external API.
IF #B: An interface between the UWB-enabled application 211b-2 and the payment applet 214b-1 within the SE (eSE). IF #B may be used to exchange an APDU via an object management application programming interface (OMAPI). For example, IF #B may be used to exchange an APDU for establishing a secure channel between the eSE and the UWBS.
IF #C: An interface between the OOB component 213b and the framework 212b or the UWB-enabled applications 211b-1 and 211b-2. For example, IF #C may be a host controller interface (HCI).
IF #D: An interface between the framework 212b and the UWB-enabled application 211b-1 or 211b-2. IF #D may be an API (framework API) provided by the framework 212b.

Although not illustrated in FIG. 2B, in order to transfer an RDS including a UWB session key, an interface between the TA (e.g., the trusted payment application) in the TEE 214b-2 and the UWBS 215b may be established or defined. In this case, a secure channel may be established between the TA and the UWBS 215b to protect an interface between the TEE and the UWBS 215b. In addition, it is also possible to connect the TA and the UWBS 215b at an HW level by newly configuring a driver TA.

<Second Electronic Device 220b>

The second electronic device 220b may be an electronic device of a business operator for a UWB-based payment service (e.g., a payment terminal (e.g., a point of service (PoS) UE of a retailer)). The second electronic device 220b may include a terminal application 221b, an OOB component 222b, and/or a UWBS 223b. As an embodiment, the terminal application 221b may be a UWB-enabled application.

According to an embodiment, not only a UE for a UWB-based payment service, but also a payment terminal may have the same configuration as that of the first electronic device 220b.

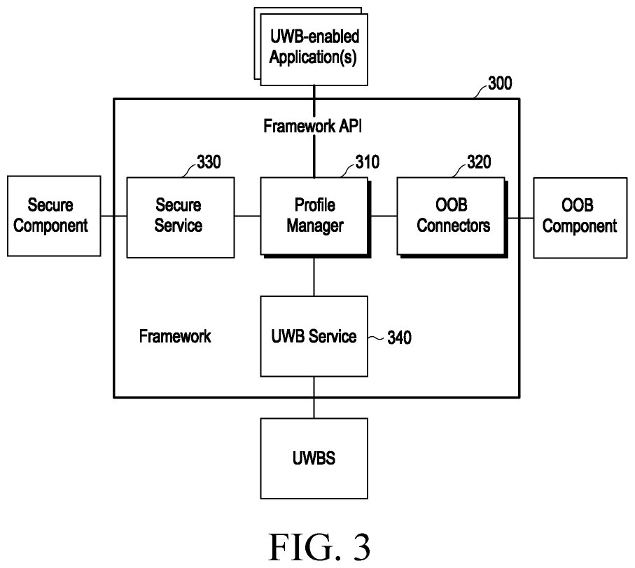

FIG. 3 illustrates an example configuration of a framework included in an electronic device supporting a UWB-based service according to an embodiment of the disclosure.

A framework 300 of FIG. 3 may be an example of the frameworks of FIG. 2A and FIG. 2B. The framework 300 of FIG. 3 may be, for example, a FiRa framework.

The framework 300 may be a set of logical software components. A UWB-enabled application may interface with the framework via a framework API provided by the framework 300.

Referring to FIG. 3, the framework 300 may include a profile manager 310, an OOB connector 320, a secure service 330, and/or a UWB service 340. However, according to an embodiment, some components may be omitted or an additional component may be included.

The profile manager component 310 may manage a profile(s) available on a ranging device (UWB device). The profile may be a set of parameters required to establish a successful UWB session between ranging devices (UWB devices). For example, the profile may include a parameter indicating a secure channel (e.g., an OOB secure channel) that is used, a UWB/OOB configuration parameter, a parameter indicating whether use of a specific secure component is mandatory, and/or a parameter related to a file structure of an ADF. In addition, the profile manager may abstract UWB and OOB configuration parameters from the UWB-enabled application.

The OOB connector component 320 may be a component for establishing an OOB connection between ranging devices (UWB devices).

The secure service component 330 may serve to perform interfacing with a secure component, such as a secure element (SE) or a trusted execution environment (TEE). The secure component may be a component that interfaces with a UWBS to transfer UWB ranging data to the UWBS.

The UWB service component 340 may be a component that provides access to the UWBS.

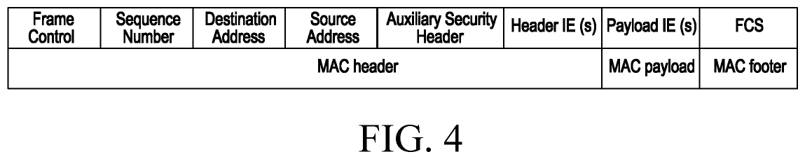

FIG. 4 illustrates a structure of a UWB MAC frame according to an embodiment of the disclosure.

In the embodiment of FIG. 4, the UWB MAC frame may be abbreviated as MAC frame or frame. As an embodiment, the UWB MAC frame may be used to transfer UWB-related data (e.g., a UWB message, a ranging message, control information, service data, application data, etc.).

Referring to FIG. 4, the UWB MAC frame may include a MAC header (MHR), a MAC payload, and/or a MAC footer (MFR).

### (1) MAC Header

The MAC header may include a frame control field, a sequence number field, a destination address field, a source address field, an auxiliary security header field, and/or at least one header IE field. According to an embodiment, some of the above-described fields may not be included in the MAC header, and an additional field(s) may be further included in the MAC header.

In an embodiment, the frame control field may include a frame type field, a security-enabled field, a frame pending field, an ACK request field (AR field), a PAN ID compression field (PAN ID present field), a sequence number suppression field, an IE present field, a destination addressing mode field, a frame version field, and/or a source addressing mode field. According to an embodiment, some of the above-described fields may not be included in the frame control field, and an additional field(s) may be further included in the frame control field.

Descriptions of the respective fields are as follows.

The frame type field may indicate a frame type. As an embodiment, a frame type may include a data type and/or a multipurpose type.

The security-enabled field may indicate whether the auxiliary security header field exists. The auxiliary security header field may include information required for security processing.

The frame pending field may indicate whether a device transmitting the frame has more data for a recipient. That is, the frame pending field may indicate whether there is a pending frame for the recipient.

The ACK request field (AR field) may indicate whether acknowledgment for frame reception is required from the recipient.

The PAN ID compression field (PAN ID present field) may indicate whether a PAN ID field exists.

The sequence number suppression field may indicate whether the sequence number field exists. The sequence number field may indicate a sequence identifier for the frame.

The IE present field may indicate whether the header IE field and the payload IE field are included in the frame.

The destination addressing mode field may indicate whether the destination address field includes a short address (e.g., 16 bits) or an extended address (e.g., 64 bits). The destination address field may indicate an address of the recipient of the frame.

The frame version field may indicate a frame version. For example, the frame version field may be configured to a value indicating IEEE std 802.15.4z-2020.

The source addressing mode field may indicate whether the source address field exists, and if the source address field exists, whether the source address field includes a short address (e.g., 16 bits) or an extended address (e.g., 64 bits). The source address field may indicate an address of an originator of the frame.

### (2) MAC Payload

The MAC payload may include at least one payload IE field. In an embodiment, the payload IE field may include a vendor-specific nested IE.

### (3) MAC Footer

The MAC footer may include an FCS field. The FCS field may include a 16-bit CRC or a 32-bit CRC.

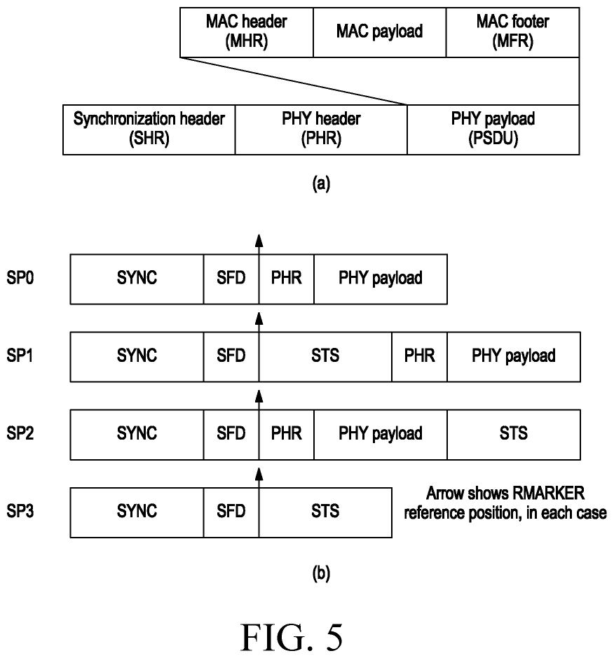

FIG. 5 illustrates a structure of a UWB PHY packet according to an embodiment of the disclosure.

Part (a) of FIG. 5 illustrates an example structure of a UWB PHY packet to which no STS packet configuration has been applied, and part (b) of FIG. 5 illustrates an example structure of a UWB PHY packet to which an STS packet configuration has been applied. The UWB PHY packet may be referred to as a PHY packet, a PHY PDU (PPDU), or a frame.

Referring to part (a) of FIG. 5, the PPDU may include a synchronization header (SHR), a PHY header (PHR), and a PHY payload (PSDU). The PSDU may include a MAC frame, and as illustrated in FIG. 4, the MAC frame may include a MAC header (MHR), a MAC payload, and/or an MFR. The synchronization header part may be referred to as a preamble, and a part including the PHY header and the PHY payload may be referred to as a data part.

The synchronization header may be used for synchronization for signal reception and may include a SYNC field and a start-of-frame delimiter (SFD).

The SYNC field may be a field including multiple preamble symbols used for synchronization between transmitting/receiving devices. A preamble symbol may be configured via one of predefined preamble codes.

The SFD field may be a field indicating an end of the SHR and a start of the data field.

The PHY header may provide information on a configuration of the PHY payload. For example, the PHY header may include information on a length of the PSDU, information indicating whether the current frame is an RFRAME (or is a data frame), etc.

The PHY layer of the UWB device may include an optional mode to provide a reduced on-air time for high density/low power operation. In this case, the UWB PHY packet may include an encrypted sequence (i.e., STS) to increase the integrity and accuracy of a ranging measurement timestamp. An STS may be included in the STS field of the UWB PHY packet and may be used for secure ranging.

Referring to part (b) of FIG. 5, for STS packet (SP) configuration 0 (SP0), the STS field is not included in the PPDU (SP0 packet). For SP configuration 1 (SP1), the STS field is located immediately after a start of frame delimiter (SFD) field and before the PHR field (SP1 packet). For SP configuration 2 (SP2), the STS field is located after the PHY payload (SP2 packet). For SP configuration 3 (SP3), the STS field is located immediately after the SFD field, and the PPDU does not include the PHR and data fields (PHY payload) (SP3 packet). In other words, for SP3, the PPDU does not include the PHR and PHY payload.

As illustrated in part (b) of FIG. 5, each UWB PHY packet may include RMARKER for defining a reference time, and RMARKER may be used to acquire a transmission time, a reception time, and/or a time period of the ranging message (frame) in the UWB ranging procedure.

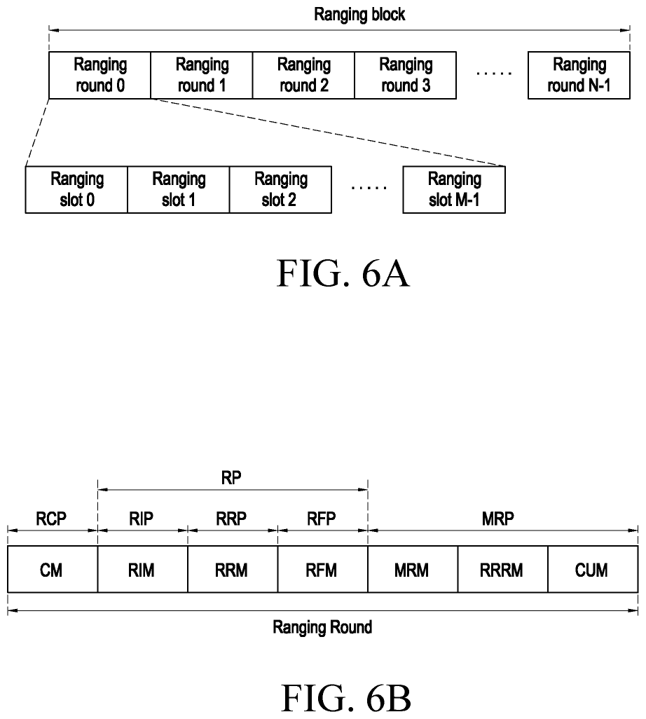

FIG. 6A illustrates an example of a ranging block structure according to an embodiment of the disclosure. FIG. 6B illustrates an example of a ranging round according to an embodiment of the disclosure.

Referring to FIG. 6A, one ranging block may include at least one ranging round, and each ranging round may include at least one ranging slot. For example, as illustrated, one ranging block may include N ranging rounds (e.g., ranging round index 0 to ranging round index N−1), and ranging round #0 may include M ranging slots (e.g., ranging slot 0 to ranging slot M−1).

A ranging block refers to a time period for ranging. A ranging round may be a period of sufficient duration for completing one entire range-measurement cycle (ranging cycle) involving a set of ranging devices participating in a ranging exchange. A ranging slot may be a period of sufficient duration for transmission of at least one ranging frame (RFRAME) (e.g., ranging initiation/response/final message, etc.).

When a ranging mode is a block-based mode, a mean time between successive ranging rounds may be a constant. Alternatively, when the ranging mode is an interval-based mode, the time between the successive ranging rounds may be changed dynamically. That is, the interval-based mode may adopt a time structure having adaptive spacing.

Ranging block may be abbreviated as block, ranging round may be abbreviated as round, and ranging slot may be abbreviated as slot.

Referring to FIG. 6B, one ranging round may include a ranging control phase (RCP), a ranging phase (RP), and/or a measurement report phase (MRP). For example, one ranging round may include one slot for the RCP, at least one slot for the RP, and/or at least one slot for the MRP.

According to an embodiment, some of the phases described above may not be included in the ranging round, or additional phases may be further included in the ranging round. For example, no RCP may be included in the ranging round. In this case, a ranging control message (RCM) may be merged with a ranging initiation message (RIM). For example, a ranging control update phase (RCUP) and/or a ranging interval update phase (RIUP) may be further included in the ranging round.

The RCP may be a phase in which a controller transmits an RCM. The RCM may be a message transmitted by the controller to configure ranging parameters. In an embodiment, the RCM may be transmitted in a first slot (slot #0) of the ranging round. The RCM may be abbreviated as control message (CM).

The RP may include a ranging initiation phase (RIP), a ranging response phase (RRP), and/or a ranging final phase (RFP).

The RIP may be a phase in which an initiator(s) transmits an RIM(s) to a responder(s).

The RRP may be a phase in which the responder(s) transmits its ranging response message (RRM) (s) to the initiator.

The RFP may be a phase in which the initiator transmits a ranging final message(s) (RFM(s)) to the responder(s). The ranging final phase may be used for DS-TWR only.

The MRP may be a phase in which participating ranging devices exchange service information related to ranging measurement. In the MRP, a measurement report message (MRM), a ranging result report message (RRRM), and/or a control update message (CUM) may be transmitted. The MRM may be a message transmitted by the UWB device to exchange measurement information. The RRRM may be a message transmitted by the UWB device for reporting a ranging result. The CUM may be a message transmitted by the controller to update control information. The CUM may be referred to as a ranging control update message (RCUM).

The RCUP may be a phase in which the controller transmits a ranging control update message (RCUM). The ranging control update phase may be included in a last slot of a set of ranging rounds designated by the RCM. The RCUM may be a message transmitted by the controller to update ranging parameters for a subsequent ranging round(s). The RCUM may be transmitted in the last slot of the ranging round(s) designated by the RCM. The RCUM may include some or all of information elements (IEs) employed by the RCM to update values of parameters.

The ranging interval update phase (RIUP) may be a phase in which the controller transmits a ranging interval update message (RIUM). The RIUM may be a message transmitted by the controller to assist synchronization between participating ranging devices or to update an interval between ranging blocks. The RIUM includes a scheduled time of a first RIUM. The RIUM may include a scheduled time of a subsequent RIUM before a subsequent ranging block starts.

If necessary, the aforementioned multiple UWB messages may be merged into one message. For example, the RCM may be merged with the RIM, and transmitted in the RIP. For example, for non-deferred DS-TWR ranging, the RFM may be merged with the MRM, and transmitted in the RFP.

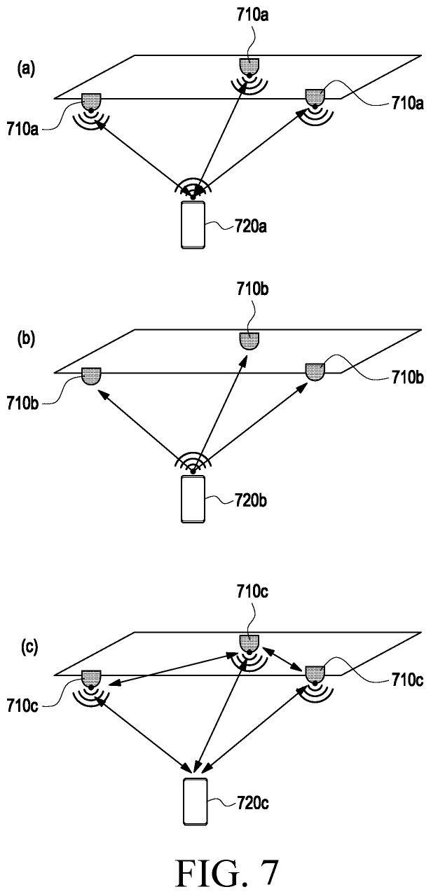

FIG. 7 illustrates various examples of a UWB ranging method according to an embodiment of the disclosure.

Part (a) of FIG. 7 illustrates an example of a two-way ranging (TWR) scheme, part (b) of FIG. 7 illustrates an example of an uplink TDoA (UL-TDoA) scheme which is a type of OWR, and part (c) of FIG. 7 illustrates an example of a downlink TDoA (DL-TDoA) scheme which is a type of OWR.

Referring to part (a) of FIG. 7, a UWB device 720a of a user may perform ranging with at least one UWB anchor 710a via a ranging exchange using multiple ranging messages. Via the ranging exchange (ranging message exchange), a time of flight (ToF) may be calculated, and a distance between the two devices may be estimated.

The UWB device 720a may perform single-sided two-way ranging (SS-TWR) or double-sided two-way ranging (DS-TWR) with the UWB anchor 710a. When performing the TWR, the UWB device 720a may serve as an initiator or a responder.

In an embodiment, the TWR may be performed according to a contention-based mode and/or a scheduling-based mode.

Referring to part (b) of FIG. 7, a UWB device (UWB tag) 720b of a user may transmit (broadcast) a ranging message to at least one UWB anchor 710b, and the at least one UWB anchor 710b may acquire TDoA based on the received ranging message and estimate a position of the UWB device 720b based on the TDoA. A TDoA scheme of the embodiment of part (b) of FIG. 7 may be referred to as an uplink TDoA (UL-TDoA) scheme.

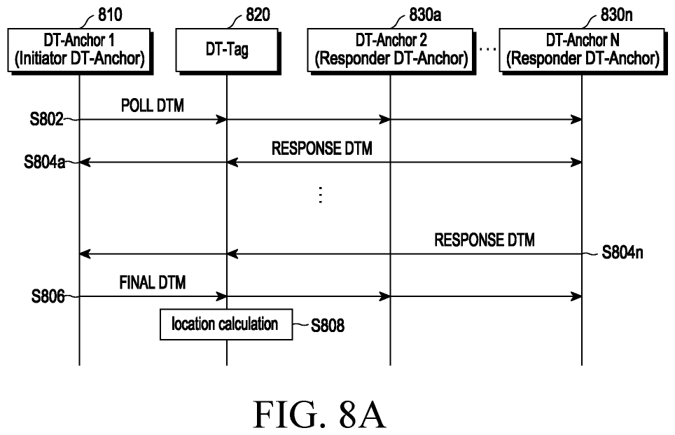

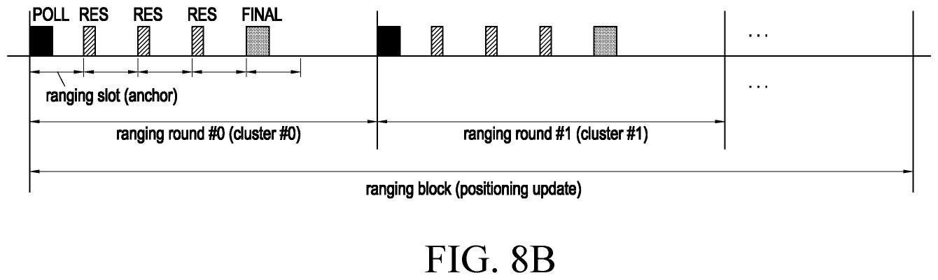

Referring to part (c) of FIG. 7, a UWB device (UWB tag or DT-tag) 720c of a user may estimate its own position by receiving ranging messages that one or more UWB anchors 710c transmit/receive to/from each other. An example of the DL-TDoA scheme is described below with reference to FIG. 8A and FIG. 8B.

FIG. 8A illustrates a method of performing UWB ranging in a DL-TDoA scheme by a UWB device according to an embodiment of the disclosure.

In the embodiment of FIG. 8A, it is assumed that one initiator anchor (initiator DT-anchor) 810 and n responder anchors 830a, . . . , 830n operate as UWB anchors (DT-anchors). However, the embodiment is not limited thereto, and the number of initiator anchors and responder anchors may be configured to vary according to an embodiment.

In operation S802, the initiator anchor 810 may initiate a DL-TDoA round by transmitting or broadcasting a poll DTM received by responder anchors in a cluster. The poll DTM may include scheduling information for each responder anchor to transmit a response DTM in an allocated ranging slot.

In an embodiment, all the responder anchors 830a, . . . , 830n may reference the scheduling information in the poll DTM, thereby identifying whether to transmit the response DTMs and identifying slots (slot indexes) used to transmit the response DTMs.

In operations S804a, . . . , S804n, all the responder anchors 830a, . . . , 830n having received the poll DTM may respond to the initiator anchor 810 by using the response DTMs in the ranging slot allocated by the poll DTM. For example, the respective responder anchors 830a, . . . , 830n may transmit or broadcast the response DTMs in their own ranging slots allocated by the poll DTM.

In operation S806, the initiator anchor 810 having received the response DTMs may additionally transmit a final DTM to the responder anchors 830a, . . . , 830n. For example, the initiator anchor 810 may transmit or broadcast the final DTM after receiving the response DTMs from the responder anchors 830a, . . . , 830n.

In operation S808, a tag device (DT-Tag) 820 may receive (or overhear) the poll DTM, the response DTMs, and the final DTM, and calculate TDoA values via information included in the messages and reception timestamps. The tag device 820 may acquire (or estimate) its own position based on the calculated TDoA values. Accordingly, the tag device 820 may estimate its own position without exposing its own position.

FIG. 8B illustrates an example of a ranging block structure for a downlink TDoA scheme according to an embodiment of the disclosure.

The ranging block structure of FIG. 8B may be an example of a ranging block structure for performing the ranging scheme of FIG. 8A.

Referring to FIG. 8B, a ranging block may include multiple ranging rounds.

As an embodiment, the ranging block may include multiple ranging rounds allocated for multiple clusters, respectively. For example, when n clusters are placed, the ranging block may include a first ranging round allocated for a first cluster, a second ranging round allocated for a second cluster, . . . , and an nth ranging round allocated for an nth cluster. Although not shown in FIG. 8B, according to an embodiment, multiple ranging rounds may be allocated to one cluster, or one ranging round may be allocated to multiple clusters.

In an embodiment, a ranging round may include multiple ranging slots. The ranging round may include multiple ranging slots allocated for respective ranging messages transmitted by anchor devices belonging to a cluster associated with the ranging round. For example, when the first cluster is configured by one initiator anchor and three responder anchors, the ranging round for the first cluster may include a first ranging slot (e.g., ranging slot index 0) allocated for transmission/reception of the poll message of the initiator anchor included in the first cluster, a second ranging slot allocated for transmission/reception of a response message of a first responder anchor, a third ranging slot allocated for transmission/reception of a response message of a second responder anchor, a fourth ranging slot allocated for transmission/reception of a response message of a third responder anchor, and a fifth ranging slot allocated for transmission/reception of a final message of the initiator anchor.

In this manner, ranging slots may be allocated to a ranging round for each cluster.

Via the ranging block structure as in the embodiment of FIG. 8B, the anchor devices of each cluster may exchange ranging messages in one cycle via their own ranging rounds in one ranging block, and a UE (tag device) may receive these ranging messages to calculate its own position. These operations may be repeated for each ranging block. Therefore, the position of the UE may be updated according to ranging block periods.

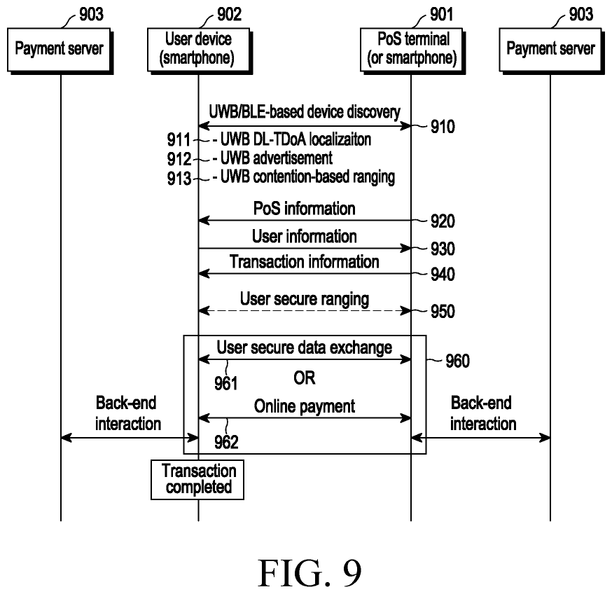

FIG. 9 illustrates a payment processing method using UWB according to an embodiment of the disclosure.

Referring to FIG. 9, payment processing using UWB may be performed by a payment terminal 901, a UE 902, and/or a payment server 903.

The payment terminal 901 may be an electronic device which communicates with the UE (or a UWB-supporting (UWB-enabled) payment application of the UE) to perform electronic fund transfers. The payment terminal 901 may be, for example, a point-of-service (PoS) terminal or smartphone supporting a payment processing function. In an embodiment, the payment terminal 901 may operate as a controller/initiator for TWR and/or a DT-anchor for DL-TDoA. The payment terminal 901 may have, for example, all or some of the components of the UWB device of FIG. 1 or all or some of the components of the electronic device (e.g., the first electronic device or the second electronic device) of FIG. 2A/B.

The UE 902 may be an electronic device of a user, which includes a UWB-enabled payment application. The UE 902 may be, for example, a smartphone of the user. In an embodiment, the UE 902 may operate as a controlee/responder for TWR and/or as a DT-tag for DL-TDoA. The UE 902 may have, for example, all or some of the components of the UWB device of FIG. 1 or all or some of the components of the electronic device (e.g., the first electronic device or the second electronic device) of FIG. 2A/B.

The payment server 903 may be a back-end server (system) which supports payment to the payment terminal 901 and/or the UE 902, such as an acquirer and an issuer.

Referring to FIG. 9, the payment processing method using UWB may include a UWB/BLE-based device discovery phase 910, a payment terminal information transmission phase 920, a user information transmission phase 930, a transaction information transmission phase 940, a UWB secure ranging phase 950, and/or a payment phase 960. However, according to an embodiment, some phases may be omitted, multiple phases may be merged into one phase, or additional phases may be further performed. In addition, the respective phases may be performed in a sequence different from that illustrated herein. For example, the transaction information transmission phase 940 may be performed after the UWB secure ranging phase 950. For example, the UWB secure ranging phase 950 may be omitted.

### [UWB/BLE-Based Device Discovery Phase 910]

In an embodiment, the UWB/BLE-based device discovery phase 910 may include a BLE advertisement operation.

As an embodiment, the BLE advertisement operation may include an operation in which the payment terminal 901, as a BLE advertiser, transmits a BLE advertisement packet to the UE. As an embodiment, the BLE advertisement packet may include at least one piece of information enabling the UE 902 to initiate at least one UWB operation. For example, the BLE advertisement packet may include a UWB payment identifier for identifying a supported payment service (or payment application). As an embodiment, at least one UWB operation that may be initiated based on reception of the BLE advertisement packet may include at least one of a DL-TDoA localization procedure 911, a UWB advertisement procedure 912, and a contention-based ranging (UWB contention-based ranging) procedure 913.

In an embodiment, the DL-TDoA localization procedure 911 may be initiated according to reception of the BLE advertisement packet or execution of the UWB-enabled payment application by a user input.

The DL-TDoA localization procedure 911 may provide a DL-TDoA-based localization service to the UE 902. Accordingly, the UE 902 may estimate a position thereof and perform a proximity-based payment transaction without exposing the position to the payment terminal 901.

As an embodiment, the DL-TDoA localization procedure 911 may include an operation in which the payment terminal 901 transmits a UWB message (e.g., a poll DTM, a response DTM, or a final DTM) for DL-TDoA.

In an embodiment, the contention-based ranging procedure 913 may be initiated according to reception of the BLE advertisement packet or execution of the UWB-enabled payment application by a user input.

When the payment terminal 901 and the UE 902 have no knowledge about each other, it is not appropriate for the UE 902 to perform scheduling-based ranging to respond to the UWB message (e.g., RIM) transmitted by the payment terminal 901. Therefore, in order for the UE 902 to respond to the UWB message transmitted by the payment terminal 901, contention-based ranging needs to be performed.

As an embodiment, the contention-based ranging procedure 913 may include an operation in which the payment terminal 901 transmits a control message for contention-based ranging. The control message may include information on a CAP for contention-based access of the UE 902.

As an embodiment, the control message (information) for contention-based ranging and the message (information) for DL-TDoA may be transmitted via a single combined UWB message.

As an embodiment, in the contention-based ranging procedure 913, the UE 902 may respond to the UWB message transmitted by the payment terminal 901 when a preconfigured condition is satisfied. For example, based on a result acquired by the DL-TDoA localization procedure 911, when a distance between the UE 902 and the payment terminal 901 is identified as being less than or equal to a preconfigured distance, the UE 902 may transmit a response message (e.g., RRM) to the payment terminal 901. As an embodiment, the UE 902 may transmit the response message in any slot within the CAP configured by the payment terminal 901.

In an embodiment, the UWB advertisement procedure 912 may be initiated according to reception of the BLE advertisement packet or execution of the UWB-enabled payment application by a user input. In the UWB advertisement procedure 912, the payment terminal 901 may transmit a UWB advertisement message (signal), and the UE 902 may measure an AoA value for the received UWB advertisement message. Based on the measured AoA value, the user's intention for payment processing may be detected. For example, a gesture (tilt UX) in which the user points the UE 902 toward the payment terminal 901 may be preconfigured as a gesture for expressing the user's intention to start payment processing. When this gesture is performed, the AoA value for the UWB advertisement message received from the payment terminal 901 may be measured to be almost zero. Therefore, in this scenario, when the AoA value is measured to be close to zero, the UE 902 may identify that the user has an intention to initiate payment processing.

### [Payment Terminal Information Transmission Phase 920]

In an embodiment, the payment terminal information transmission phase 920 may include an operation in which the payment terminal 901 transmits payment terminal information to the UE 902. The payment terminal information may be referred to as PoS information.

As an embodiment, the payment terminal information may be included in a control message for contention-based ranging, so as to be transmitted from the payment terminal 901 to the UE 902. As an embodiment, the payment terminal information may be included in a message for DL-TDoA (e.g., a poll DTM, a response DTM, or a final DTM), so as to be transmitted from the payment terminal 901 to the UE 902. As an embodiment, the payment terminal information may be included in a UWB message, in which the control message for contention-based ranging and the message for DL-TDoA are combined, so as to be transmitted from the payment terminal 901 to the UE 902. As an embodiment, the payment terminal information may be included in a UWB message, in which the control message for contention-based ranging and an initiation message and data message of contention-based ranging are combined, so as to be transmitted from the payment terminal 901 to the UE 902.

As an embodiment, the payment terminal information may be included in a UWB message, in which the message for DL-TDoA (e.g., a poll DTM, a response DTM, or a final DTM), the control message for contention-based ranging, and the initiation message and data message of contention-based ranging are combined, so as to be transmitted from the payment terminal 901 to the UE 902.

Accordingly, the payment terminal information may be transmitted via UWB in-band.

As an embodiment, the payment terminal information may include identification information (e.g., an identifier) of the payment terminal 901 (or a merchant associated with the payment terminal 901), name information (e.g., a nickname) of the payment terminal 901 (or a merchant associated with the payment terminal 901), and/or random challenge information (posChallenge) of the payment terminal 901 for mutual authentication. The random challenge information (posChallenge) of the payment terminal 901 may be a random value (e.g., random number) generated by the payment terminal 901, which is used for mutual authentication in a random challenge manner.

As an embodiment, the payment terminal information may be included in a payload within a content field of the data message so as to be transmitted. The payload of the data message may be an unencrypted public message. Table 5 below shows an example of TLV format messages which may be included in the payload of the DM payload IE so as to be transmitted by the payment terminal, wherein the payload of the DM payload IE is transmitted in combination with the contention-based initiation message. The payment terminal may configure some or multiple messages below in the TLV format, and add the TLV format messages to the payload of the DM payload IE, so as to transmit the same to the UE.

TABLE 5

| | Value of | |
|---|---|---|
| Message | Type | Description |
| Merchant | 0 × XX | Information of a store or merchant |
| identifier | | The Merchant identifier may be |
| | | defined by a payment service |
| | | provider, |
| Request to | 0 × XX | The message sent by the Merchant |
| connect | | Device when a clerk selects the |
| | | Customer Device to proceed a |
| | | payment. This message is only |
| | | sent by the Merchant Device. |
| Payment | 0 × XX | The list of payment protocol |
| protocol | | identifiers that the Merchant |
| | | Device or the Customer Device |
| | | support. |
| PoSChallenge | 0 × X | Random challenge value of PoS |
| Proprietary | 0 × YY- | Any proprietary usage |
| range: | 0 × ZZ | |
| RFU | All not | Reserved for Future Usage |
| | defined | |
| | values | |

### [User Information Transmission Phase 930]

In an embodiment, the user information transmission phase 930 may include an operation in which the UE 902 transmits user information to the payment terminal 901.

As an embodiment, in the contention-based ranging procedure 913, the user information may be included in a response message (e.g., RRM for SS-TWR) transmitted from the UE 902 to the payment terminal 901, so as to be transmitted. Accordingly, the user information may be transmitted via UWB in-band. As an embodiment, the user information may be included in a UWB message, in which the response message of contention-based ranging and a data message are combined, so as to be transmitted from the UE 902 to the payment terminal 901. As an embodiment, the user information may be included in a payload within a content field of the data message so as to be transmitted. The payload of the data message may be an unencrypted public message.

As an embodiment, the user information may include identification information (e.g., an identifier) of the UE 902 (or the user of the UE 902), name information (e.g., a nickname) of the UE 902 (or the user of the UE 902), and/or random challenge information (userChallenge) of the UE 902 for mutual authentication. The random challenge information (userChallenge) of the UE 902 may be a random value (e.g., random number) generated by the UE 902 used for mutual authentication in a random challenge manner.

TABLE 6

| | Value of | |
|---|---|---|
| Message | Type | Description |
| Customer | 0 × XX | Information of a customer. |
| identifier | | The Merchant identifier may |
| | | be defined by a payment |
| | | service provider. |
| Accept to | 0 × XX | The message sent by the |
| connect | | Customer Device as a |
| | | response of ‘Request to |
| | | connect’ when the user |
| | | confirms to connect with |
| | | the Merchant Device |
| | | which sent the ‘Request |
| | | to connect’. |
| | | This message is only sent |
| | | by the Customer Device. |
| Reject to | 0 × XX | The message sent by the |
| connect | | Customer Device as a |
| | | response of ‘Request to |
| | | connect’ when the user |
| | | confirms to connect with |
| | | the Merchant Device |
| | | which sent the ‘Request |
| | | to connect’. |
| | | This message is only sent |
| | | by the Customer Device. |
| Payment | 0 × XX | The list of payment protocol |
| protocol | | identifiers that the Merchant |
| | | Device or the Customer |
| | | Device support. |
| Shipping | 0 × XX | Shipping information that |
| information | | will be used by the |
| | | Customer Device and the |
| | | Merchant Device to |
| | | complete a payment trans- |
| | | action protocol, especially, |
| | | filling out a form of a |
| | | billing or a receipt. |
| UserChallenge | 0 × XX | Random challenge value of User |
| Proprietary | 0 × YY- | Any proprietary usage |
| range: | 0 × ZZ | |
| RFU | All not | Reserved for Future Usage |
| | defined | |
| | values | |

### [Transaction Information Transmission Phase 940]

In an embodiment, the transaction information transmission phase 940 may include an operation in which the payment terminal 901 transmits transaction information to the UE (or a UWB-enabled payment application of the UE 902).

As an embodiment, the transaction information may be transmitted via UWB data messages (data frames).

As an embodiment, the transaction information may be payment-related private information, such as a merchant name and a transaction amount, transmitted from the payment terminal 901 to the UE 902. The transaction information may be data in the TLV format, which includes some or all of messages, such as a supported payment protocol type, a transaction amount, and a bill.

TABLE 7

| | Value of | |
|---|---|---|
| Message | Type | Description |
| Payment | 0 × XX | The list of payment protocol identi- |
| protocol | | fiers that the Merchant Device or the |
| | | Customer Device support. |
| Amount to | 0 × XX | The amount of payment that will |
| pay | | charge to the Customer Device. |
| | | This message is only sent by the |
| | | Merchant Device. |
| Billing | 0 × XX | Billing information that will be used |
| information | | by the Customer Device and the |
| | | Merchant Device to complete a |
| | | payment transaction protocol, |
| | | especially, filling out a form of a |
| | | billing or a receipt. |
| Shipping | 0 × XX | Shipping information that will be |
| information | | used by the Customer Device |
| | | and the Merchant Device to |
| | | complete a payment transaction |
| | | protocol, especially, filling out a |
| | | a form of a billing or a receipt. |
| Proprietary | 0 × YY- | Any proprietary usage |
| range: | 0 × ZZ | |
| RFU | All not | Reserved for Future Usage |
| | defined | |
| | values | |

As an embodiment, the transaction information transmission phase 940 may be performed after a secure channel (session) is established. For example, the transaction information transmission phase 940 may be performed after a secure session is established via the UWB secure ranging procedure 950.

### [UWB Secure Ranging Phase 950]

In an embodiment, the UWB secure ranging phase 950 may include a procedure of performing secure ranging between the payment terminal 901 and the UE 902 by using STS (e.g., dynamic STS). Accordingly, a secure session may be established between the payment terminal 901 and the UE 902.

As an embodiment, the UWB secure ranging phase 950 may be an optional phase.

### [Payment Phase 960]

In an embodiment, the payment phase 960 may include a procedure 961 in which the UE 902 and the payment terminal 901 exchange UWB secure data including payment information.

As an embodiment, the payment information may be transmitted via UWB data messages (data frames).

As an embodiment, the payment information may be payment-related private information, such as a card number transmitted from the UE 902 to the payment terminal 901. As an embodiment, in the procedure 961 of exchanging the UWB secure data, the payment information may be encrypted and transmitted through a secure channel.

In an embodiment, the payment phase 960 may include a procedure 962 in which the UE 902 and the payment terminal 901 perform an online payment.

By using the information exchanged via the payment phase 960, the payment terminal 901 and/or the UE 902 may perform back-end interaction with the payment server 903 so as to complete the transaction.

Hereinafter, a method of performing both a contention-based ranging procedure and a DL-TDoA procedure is described.

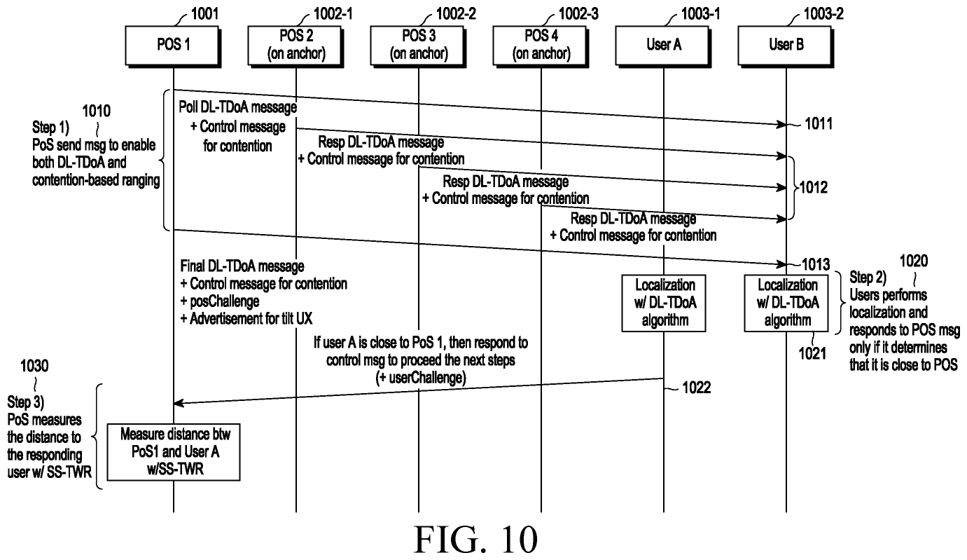

FIG. 10 illustrates a method of performing both DL-TDoA ranging and contention-based ranging by a UWB device according to an embodiment of the disclosure.

A ranging procedure of the embodiment of FIG. 10 may be a ranging procedure in which both DL-TDoA ranging and contention-based ranging are performed.

When compared to the DL-TDoA of FIG. 8A, UWB messages used in the ranging procedure of the embodiment of FIG. 9 may include both a payload IE for contention-based ranging and a payload IE for DL-TDoA.

In the embodiment of FIG. 10, for convenience of description, it is assumed that four anchors including one initiator anchor 1001 and three responder anchors 1002-1 to 1002-3, and two UEs 1003-1 and 1003-2 perform a ranging procedure, but the embodiment is not limited thereto. For example, a different number of anchors and UEs compared to those illustrated herein may participate in the ranging procedure.

In an embodiment, the initiator anchor 1001 may be a payment terminal (e.g., the payment terminal 901 of FIG. 9) for a UWB-based payment service. As an embodiment, the initiator anchor 1001 may serve as both a controller/initiator for contention-based ranging (TWR) and a DT-anchor (e.g., initiator DT-anchor) for DL-TDoA (OWR).

In an embodiment, the responder anchors 1002-1, 1002-2, and 1002-3 may be payment terminals (e.g., the payment terminal 901 of FIG. 9) for a UWB-based payment service. As an embodiment, the responder anchors 1002-1, 1002-2, and 1002-3 may serve as both controllers/initiators for contention-based ranging (TWR) and DT-anchors (e.g., responder DT-anchors) for DL-TDoA (OWR).

In an embodiment, the UEs 1003-1 and 1003-2 may be UEs (e.g., the UE 902 of FIG. 9) for a UWB-based payment service. As an embodiment, the UEs 1003-1 and 1003-2 may serve as both controlees/responders for contention-based ranging (TWR) and DT-tags for DL-TDoA (OWR).

In an embodiment, the ranging procedure of the embodiment of FIG. 10 may be performed in one ranging round. For example, message exchanges between the devices for performing the ranging procedure in FIG. 10 may be performed in one ranging round.

Referring to FIG. 10, the ranging procedure may include phase 1010, phase 1020, and/or phase 1030. According to an embodiment, some phases or some operations within the phases may be omitted, additional phases may further be performed, and a sequence of the respective phases may be changed.

### [Phase 1010]

Phase 1010 may be a phase for transmitting or broadcasting a UWB message which enables both DL-TDoA and contention-based ranging for the anchors 1001, 1002-1, and 1002-3. Phase 1010 may include at least one of operations 1011 to 1013 which will be described below.

In operation 1011, the initiator anchor 1001 may transmit or broadcast a first UWB message to initiate a ranging procedure. The first UWB message may be used to provide both a RIM function for contention-based ranging and a poll DTM function for DL-TDoA. In addition, the first UWB message may be used for UWB advertisement for tilt UX. In addition, the first UWB message may be used to transmit payment terminal information. The first UWB message may be referred to as an initiation message, a first DTM, a poll DTM, etc.

In an embodiment, the first UWB message may include both a payload IE for contention-based ranging and a payload IE for DL-TDoA.

In an embodiment, the payload IE for contention-based ranging in the first UWB message may include data of a control message for contention-based ranging. As an embodiment, the control message for contention-based ranging may be control message type 2. As an embodiment, the control message may include information (CAP size information) indicating a size of a CAP.

In an embodiment, the payload IE for DL-TDoA in the first UWB message may include data of the poll DTM. As an embodiment, the payload IE for DL-TDoA in the first UWB message may include scheduling information for each responder anchor 1002-1, 1002-2, or 1002-3.

In operation 1012, each responder anchor 1002-1, 1002-2, or 1002-3 may transmit or broadcast a second UWB message in response to the first UWB message. The second UWB message may be used to provide both the RIM function for contention-based ranging and a response DTM function for DL-TDoA. In addition, the second UWB message may be used for UWB advertisement for tilt UX. In addition, the second UWB message may be used to transmit payment terminal information. The second UWB message may be referred to as a response message, a second DTM, a response DTM, etc.

In an embodiment, each responder anchor 1002-1, 1002-2, or 1002-3 may transmit or broadcast the second UWB message in its own ranging slot, based on the scheduling information in the first UWB message.

In an embodiment, the second UWB message may include both a payload IE for contention-based ranging and a payload IE for DL-TDoA.

In an embodiment, the payload IE for contention-based ranging in the second DTM may include data of a control message for contention-based ranging. As an embodiment, the control message for contention-based ranging may be control message (CM) type 2. As an embodiment, the control message for contention-based ranging in the second DTM may be a synchronized (synced) control message.

As an embodiment, the synchronized control message may be a control message synchronized with the control message included in the first UWB message transmitted by the initiator anchor 1001 in operation 1011.

As an embodiment, CAPs for contention-based ranging may be configured to be the same time period via the synchronized control messages. In other words, the control messages being synchronized with each other may indicate that the CAPs configured by the synchronized control messages have the same time period. For example, when a CAP configured by the control message included in the first control message is configured to be a period corresponding to ranging slot #11 to ranging slot #20, the control messages synchronized with the control message included in the first control message may also configure CAPs to be the same as the period corresponding to ranging slot #11 to ranging slot #20. Via the synchronized control messages, the CAPs configured by the respective control messages may be configured to be the same time period without conflicting with each other.

Hereinafter, synchronization of the control messages is described via examples.

The control message included in the first UWB message may include CAP size information. The CAP size information may designate a size of the CAP in which the UEs 1003-1 and 1003-2 may make a contention-based response.

The CAP having the size of the CAP may be configured after a point in time when the initiator anchor 1001 and the responder anchors 1002-1 to 1002-3 transmit all UWB messages for DL-TDoA, that is, a point in time when the operation of phase 1010 is completed.

If it is assumed that phase 1010 ends at ranging slot #10 and the size of the CAP designated by the CAP size information of the control message in the first UWB message is 10, the CAP configured by the control message in the first UWB message may be configured to be a time period (e.g., a period from ranging slot #11 to ranging slot #20) including 10 ranging slots after ranging slot #10. In this case, the CAP configured by the second UWB message having the control message synchronized with the control message in the first UWB message should also be configured to be a time period (e.g., a period from ranging slot #11 to ranging slot #20) including 10 ranging slots after ranging slot #10. Therefore, a value of the size of the CAP configured by the control message in the first UWB message and index values of ranging slots included in the CAP should be equal to a value of the size of the CAP configured by the synchronized control message in the second UWB message and index values of ranging slots included in the CAP. Via these synchronized (synced) control messages, time periods in which the UEs 1003-1 and 1003-2 may make contention-based responses may all be configured to have the same time period without a conflict.

Hereinafter, a method of configuring synchronized (synced) control messages is described via examples.

For example, as illustrated, when it is assumed that there are one initiator anchor and three responder anchors, and a CAP size is five, a method of configuring synchronized control messages may be as follows.

In ranging slot #0, the initiator anchor transmits a first UWB message (initiation message).

In ranging slots #1, #2, and #3, the responder anchors transmit second UWB messages (first response messages), respectively.

In ranging slot #4, the initiator anchor transmits a third UWB message (final message).

UEs are able to attempt to make a contention-based response by randomly selecting one of ranging slots #5, #6, #7, #8, and #9.

In this scenario, when the initiator anchor transmits the first UWB message in ranging slot #0, the initiator anchor may configure a value of CAP size information in a control message to be 5, and configure a value of responder management list size (RML size) information to be 4. Accordingly, the UEs may skip 4 ranging slots corresponding to the value of 4 designated by the RML size information in ranging slot #0 in which the initiator anchor has transmitted the first UWB message, and then, from ranging slot #5, perform contention-based response in 5 ranging slots corresponding to the value of 5 designated by the CAP size information. That is, based on the CAP size information (=5) and the RML size information (=4) of the control message in the first UWB message, the UEs may identify that a period corresponding to ranging slots #5 to #9 is the CAP, and transmit a response message in any slot within the CAP.

Then, when the first responder anchor transmits a second UWB message in ranging slot #1, the first responder anchor may equally configure the value of CAP size information in the control message to be 5, and configure the value of RML size information to be 3. Accordingly, the UEs may skip 3 ranging slots corresponding to the value of 3 designated by the RML size information from ranging slot #1 in which the first responder anchor has transmitted the second UWB message, and then, from ranging slot #3, perform contention-based response in 3 ranging slots corresponding to the value of 3 designated by the CAP size information. That is, the same CAP may be configured via the control message of the initiator anchor and the synchronized control message of the first responder anchor.

Likewise, control messages in UWB messages transmitted by all remaining anchors may be configured to designate CAPs to be the same period corresponding to ranging slots #5, #6, #7, #8, and #9, so that the control messages may be synchronized with each other.

In an embodiment, the payload IE for DL-TDoA in the second UWB message may include data of the response DTM. As an embodiment, the payload IE for DL-TDoA in the second UWB message may include first reply time information. First reply time information of a corresponding responder anchor may include a first responder reply time indicating an elapsed time between a time when the responder anchor receives the first UWB message and a time when the second UWB message is transmitted.

In operation 1013, the initiator anchor 1001 may transmit or broadcast a third UWB message in response to the second UWB messages from the responder anchors 1002-1, 1002-2, and 1002-3. The third UWB message may be used to provide both the RIM function for contention-based ranging and a final DTM function for DL-TDoA. In addition, the third UWB message may be used for UWB advertisement for tilt UX. In addition, the third UWB message may be used to transmit payment terminal information. The third UWB message may be referred to as a final message, a third DTM, or a final DTM.

In an embodiment, the third UWB message may include both a payload IE for contention-based ranging and a payload IE for DL-TDoA.

In an embodiment, the payload IE for contention-based ranging in the third UWB message may include data of a control message for contention-based ranging. As an embodiment, the control message for contention-based ranging in the third DTM may be a synchronized control message. For synchronization of the control messages, reference may be made to the description in phase 1012.

In an embodiment, the payload IE for DL-TDoA in the third UWB message may include data of the final DTM. As an embodiment, the payload IE for DL-TDoA in the third UWB message may include second reply time information. The second reply time information may include a list of reply times for the second UWB messages from the respective responder anchors 1002-1, 1002-2, and 1002-3. A reply time for the second UWB message may be an elapsed time between a time when the initiator anchor 1001 receives the second UWB message from the corresponding responder anchor and a time when the third UWB message is transmitted.

In an embodiment, the third UWB message may be used as a UWB advertisement message for UWB advertisement. As an embodiment, the third UWB message may include information to be used as the UWB advertisement message. The UEs 1003-1 and 1003-2 may perform a UWB advertisement procedure for tilt UX (e.g., the UWB advertisement procedure 912 of FIG. 9) by using the third UWB message.

In an embodiment, the third UWB message may further include random challenge information (posChallenge) of the anchors, which is used for mutual authentication.

### [Phase 1020]

Phase 1020 may be a phase for the UEs to perform DL-TDoA localization and perform contention-based response to the anchors. Phase 1020 may include at least one of the following operations 1021 to 1022.

In operation 1021, the UEs 1003-1 and 1003-2 may receive the first UWB message, the second UWB messages, and the third UWB message, calculate TDoA based on the payload IE for DL-TDoA in each UWB message, and estimate their own positions based on the calculated TDoA.

In operation 1022, each UE 1003-1 or 1003-2 may transmit a ranging response message (RRM) for contention-based ranging to a selected anchor.

In an embodiment, the UE 1003-1 or 1003-2 may select one of the anchors 1001 and 1002-1 to 1002-3, based on preconfigured criteria. For example, the UE 1003-1 or 1003-2 may select, based on a DL-TDoA result, an anchor located within a preconfigured distance (e.g., 2 meters) from the position of the UE. If there are multiple anchors located within the preconfigured distance, the UE may select an anchor located at a closest distance among the multiple anchors.

In an embodiment, the UE 1003-1 or 1003-2 may transmit a ranging response message in any ranging slot within a CAP. As an embodiment, the CAP may be configured via the control message in the first UWB message, the synchronized control message in the second UWB message, and the synchronized control message in the third UWB message. The CAPs configured via the synchronized control messages may have the same time period.

In an embodiment, the ranging response message may include user information. For example, the ranging response message may additionally include a random challenge value (user challenge) that is randomly generated by the UE. In this case, the random challenge value may be included in the data message payload IE (DM payload IE) so as to be transferred, the DM payload IE being piggybacked in the RRM to be transferred. The user challenge (userChallenge) value transferred in operation 1022 may be used as a security tool which verifies whether the payment terminal 1001 has a valid certificate and a corresponding private key.

In an embodiment, the ranging response message may include reply time information that specifies an elapsed time between a time when the UWB message (e.g., the first UWB message, the second UWB message, or the third UWB message) is received from the selected anchor and a time when the ranging response message is transmitted.

### [Phase 1030]

Phase 1030 may be a phase for the anchor having received the ranging response message to measure a distance to the UE that has responded. As an embodiment, the distance measurement may be based on SS-TWR.

In phase 1030, the anchor having received the response message from the UE may perform an SS-TWR operation based on the ranging response message. Accordingly, the anchor may acquire an accurate distance to the UE.

Unlike the embodiment of FIG. 8A, in the embodiment of FIG. 10, the UWB messages used in the ranging procedure include not only the payload IE for DL-TDoA but also the payload IE for contention-based ranging. Therefore, both DL-TDoA ranging and contention-based ranging may be performed in one ranging cycle (ranging round). This may increase the efficiency of resource utilization.

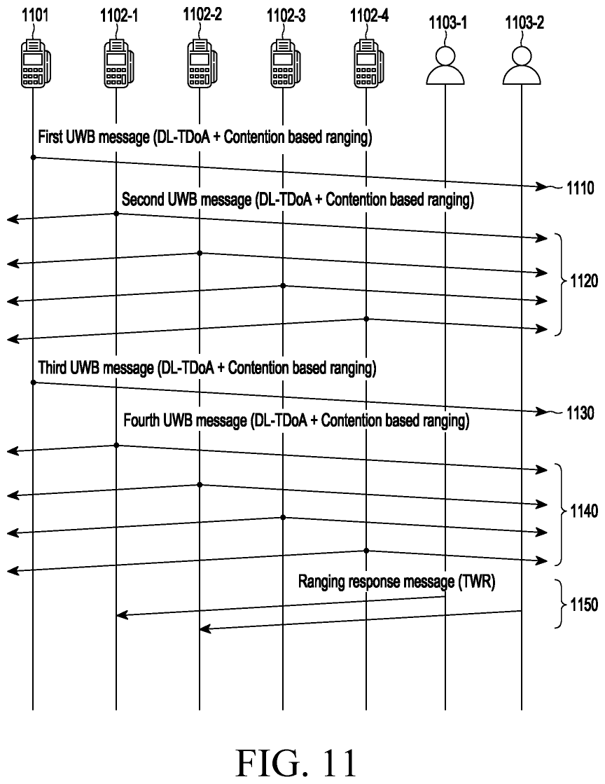

FIG. 11 illustrates a method of performing both DL-TDoA ranging and contention-based ranging by a UWB device according to an embodiment of the disclosure.

A ranging procedure of the embodiment of FIG. 11 may be a ranging procedure in which both DL-TDoA ranging and contention-based ranging are performed.

When compared to FIG. 8A, UWB messages used in the ranging procedure of the embodiment of FIG. 11 may include both a payload IE for contention-based ranging and a payload IE for DL-TDoA.

When compared to the DL-TDoA procedures of FIG. 8A and FIG. 10, in the ranging procedure in the embodiment of FIG. 11, each responder anchor may transmit a response DTM (second DTM) twice in one ranging cycle (DL-TDoA ranging cycle).

In the embodiment of FIG. 11, for convenience of description, it is assumed that five anchors including one initiator anchor 1101 and four responder anchors 1102-1 to 1102-4, and two UEs 1103-1 and 1103-2 perform a ranging procedure, but the embodiment is not limited thereto. For example, a different number of anchors and UEs compared to those illustrated herein may participate in the ranging procedure.

In an embodiment, the initiator anchor 1101 may be a payment terminal (e.g., the payment terminal 901 of FIG. 9) for a UWB-based payment service. As an embodiment, the initiator anchor 1101 may serve as both a controller/initiator for contention-based ranging (TWR) and a DT-anchor (e.g., initiator DT-anchor) for DL-TDoA (OWR).

In an embodiment, the responder anchors 1102-1, 1102-2, 1102-3, and 1102-4 may be payment terminals (e.g., the payment terminal 901 of FIG. 9) for a UWB-based payment service. As an embodiment, the responder anchors 1102-1, 1102-2, 1102-3, and 1102-4 may serve as both controllers/initiators for contention-based ranging (TWR) and DT-anchors (e.g., responder DT-anchors) for DL-TDoA (OWR).

In an embodiment, the UEs 1103-1 and 1103-2 may be UEs (e.g., the UE 902 of FIG. 9) for a UWB-based payment service. As an embodiment, the UEs 1103-1 and 1103-2 may serve as both controlees/responders for contention-based ranging (TWR) and DT-tags for DL-TDoA (OWR).

In an embodiment, the ranging procedure of the embodiment of FIG. 11 may be performed in one ranging round. For example, operations 1110 to 1150 of FIG. 11 may be performed in one ranging round.

Referring to FIG. 11, in operation 1110, the initiator anchor 1101 may transmit or broadcast a first UWB message to initiate a ranging procedure. The first UWB message may be used to provide both a RIM function for contention-based ranging and a poll DTM function for DL-TDoA. In addition, the first UWB message may be used for UWB advertisement for tilt UX. In addition, the first UWB message may be used to transmit payment terminal information. The first UWB message may be referred to as an initiation message, a first DTM, a poll DTM, etc.

In an embodiment, the first UWB message may include both a payload IE for contention-based ranging and a payload IE for DL-TDoA.

In an embodiment, the payload IE for contention-based ranging in the first UWB message may include data of a control message for contention-based ranging. As an embodiment, the control message for contention-based ranging may be control message type 2. As an embodiment, the control message may include information (CAP size information) indicating a size of a CAP.

In an embodiment, the payload IE for DL-TDoA in the first UWB message may include data of the poll DTM. As an embodiment, the payload IE for DL-TDoA in the first UWB message may include scheduling information for each responder anchor 1102-1, 1102-2, 1102-3, or 1102-4.

In operation 1120, each responder anchor 1102-1, 1102-2, 1102-3, or 1102-4 may transmit or broadcast a second UWB message in response to the first UWB message. The second UWB message may be used to provide both the RIM function for contention-based ranging and a response DTM function for DL-TDoA. In addition, the second UWB message may be used for UWB advertisement for tilt UX. In addition, the second UWB message may be used to transmit payment terminal information. The second UWB message may be referred to as a first response message, a second DTM, a response DTM, etc.

In an embodiment, each responder anchor 1102-1, 1102-2, 1102-3, or 1102-4 may transmit or broadcast the second UWB message in its own ranging slot, based on first scheduling information in the first UWB message.

In an embodiment, the second UWB message may include both a payload IE for contention-based ranging and a payload IE for DL-TDoA.

In an embodiment, the payload IE for contention-based ranging in the second DTM may include data of a control message for contention-based ranging. As an embodiment, the control message for contention-based ranging may be control message (CM) type 2. As an embodiment, the control message for contention-based ranging in the second DTM may be a synchronized (synced) control message.

As an embodiment, the synchronized control message may be a control message synchronized with the control message included in the first UWB message transmitted by the initiator anchor 1101 in operation 1110.

As an embodiment, CAPs for contention-based ranging may be configured to be the same time period via the synchronized control messages. In other words, the control messages being synchronized with each other may indicate that the CAPs configured by the synchronized control messages have the same time period. For example, when a CAP configured by the control message included in the first control message is configured to be a period corresponding to ranging slot #11 to ranging slot #20, the control messages synchronized with the control message included in the first control message may also configure CAPs to be the same as the period corresponding to ranging slot #11 to ranging slot #20. Via the synchronized control messages, the CAPs configured by the respective control messages may be configured to be the same time period without conflicting with each other. For synchronization of the control messages, reference may be made to the description in phase 1012 of FIG. 10.

In an embodiment, the payload IE for DL-TDoA in the second UWB message may include data of the response DTM. As an embodiment, the payload IE for DL-TDoA in the second UWB message may include first reply time information. First reply time information of a corresponding responder anchor may include a first responder reply time indicating an elapsed time between a time when the responder anchor receives the first DTM and a time when the second DTM is transmitted.

In operation 1130, the initiator anchor 1101 may transmit or broadcast a third UWB message in response to the second UWB messages from the responder anchors 1102-1, 1102-2, 1102-3, and 1102-4. The third UWB message may be used to provide both the RIM function for contention-based ranging and a final DTM function for DL-TDoA. In addition, the third UWB message may be used for UWB advertisement for tilt UX. In addition, the third UWB message may be used to transmit payment terminal information. The third UWB message may be referred to as a final message, a third DTM, or a final DTM.

In an embodiment, the third UWB message may include both a payload IE for contention-based ranging and a payload IE for DL-TDoA.

In an embodiment, the payload IE for contention-based ranging in the third UWB message may include data of a control message for contention-based ranging. As an embodiment, the control message for contention-based ranging in the third DTM may be a synchronized control message. For synchronization of the control messages, reference may be made to the description in phase 920 of FIG. 9.

In an embodiment, the payload IE for DL-TDoA in the third UWB message may include data of the final DTM. As an embodiment, the payload IE for DL-TDoA in the third UWB message may include second reply time information. The second reply time information may include a list of reply times for the second DTMs from the respective responder anchors 1102-1, 1102-2, 1102-3, and 1102-4. A reply time for the second DTM may be an elapsed time between a time when the initiator anchor 1101 receives the second DTM from the corresponding responder anchor and a time when the third DTM is transmitted.

In operation 1140, each responder anchor 1102-1, 1102-2, 1102-3, or 1102-4 may transmit or broadcast a fourth UWB message in response to the third UWB message. The fourth UWB message may be used to provide both the RIM function for contention-based ranging and the response DTM function for DL-TDoA. In addition, the fourth UWB message may be used for UWB advertisement for tilt UX. In addition, the fourth UWB message may be used to transmit payment terminal information. As an embodiment, the message format of the fourth UWB message may be identical to the message format of the second UWB message. The fourth UWB message may be referred to as a second response message, a second DTM, a response DTM, etc.

In an embodiment, each responder anchor 1102-1, 1102-2, 1102-3, or 1102-4 may transmit or broadcast the fourth UWB message in its own ranging slot, based on second scheduling information in the first UWB message.

In an embodiment, the fourth UWB message may include both a payload IE for contention-based ranging and a payload IE for DL-TDoA.

In an embodiment, the payload IE for contention-based ranging in the fourth UWB message may include data of a control message for contention-based ranging. As an embodiment, the control message for contention-based ranging may be control message (CM) type 2. As an embodiment, the control message for contention-based ranging in the fourth DTM may be a synchronized (synced) control message. For synchronization of the control messages, reference may be made to the description in phase 920.

In an embodiment, the payload IE for DL-TDoA in the fourth UWB message may include data of the response DTM. As an embodiment, the payload IE for DL-TDoA in the fourth UWB message may include third reply time information. Third reply time information of a corresponding responder anchor may include a second responder reply time indicating an elapsed time between a time when the responder anchor receives the third DTM and a time when the fourth DTM is transmitted.

In an embodiment, the UEs 1103-1 and 1003-2 may receive the first UWB message, the second UWB messages, the third UWB message, and the fourth UWB messages, calculate TDoA based on the payload IE for DL-TDoA in each UWB message, and estimate their own positions based on the calculated TDoA.

In operation 1150, each UE 1103-1 or 1003-2 may transmit a ranging response message (RRM) for contention-based ranging to a selected anchor. The anchor having received the response message from the UE may perform an SS-TWR operation based on the ranging response message. Accordingly, the anchor may acquire an accurate distance to the UE. The ranging response message may be referred to as a fifth UWB message or an extended ranging response message (extended RRM).

In an embodiment, the UE 1103-1 or 1003-2 may select one of the anchors 1101 and 1102-1 to 1102-4, based on preconfigured criteria. For example, the UE 1103-1 or 1003-2 may select, based on a DL-TDoA result, an anchor located within a preconfigured distance (e.g., 2 meters) from the position of the UE. If there are multiple anchors located within the preconfigured distance, the UE may select an anchor located at a closest distance among the multiple anchors.

In an embodiment, the UE 1103-1 or 1103-2 may transmit a ranging response message in any ranging slot within a CAP. As an embodiment, the CAP may be configured via the control message in the first UWB message, the synchronized control message in the second UWB message, the synchronized control message in the third UWB message, and the synchronized control message in the fourth UWB message. The CAPs configured via the synchronized control messages may have the same time period.

In an embodiment, the ranging response message may include user information.

In an embodiment, the ranging response message may include two pieces of reply time information for the selected anchor. For example, if the responder anchor 1102-1 is selected, the ranging response message may include reply time information for the second UWB message of the responder anchor 1102-1 and reply time information for fourth UWB message of the responder anchor 1102-1. The reply time information for the second UWB message of the responder anchor 1102-1 may be an elapsed time between a reception time of the second UWB message of the responder anchor 1102-1 and a transmission time of the ranging response message from the UE. The reply time information for the fourth UWB message of the responder anchor 1102-1 may be an elapsed time between a reception time of the fourth UWB message of the responder anchor 1102-1 and a transmission time of the ranging response message from the UE.

For the embodiments of FIGS. 8A and 10, in one DL-TDoA ranging cycle, the initiator anchor transmits two DTMs, but the responder anchors may transmit only one DTM. Therefore, for the embodiments of FIGS. 8A and 10, it is difficult for the UE to estimate CFOs for the responder anchors.

However, for the embodiment of FIG. 11, all the anchors transmit two or more DTMs (UWB messages) in one DL-TDoA ranging cycle. Therefore, the UE may receive two or more DTMs from each anchor. As a result, the UE may estimate a clock frequency offset (CFO) for any anchor, based on two or more DTMs received from each anchor. In addition, since each anchor transmits two or more DTMs, the possibility of the UE to acquire TDoA may be increased.

In addition, when compared to the embodiment of FIG. 8A, in the embodiment of FIG. 11, the UWB messages used in the ranging procedure include not only the payload IE for DL-TDoA but also the payload IE for contention-based ranging. Therefore, both DL-TDoA ranging and contention-based ranging may be performed in one ranging cycle (ranging round). This may increase the efficiency of resource utilization.

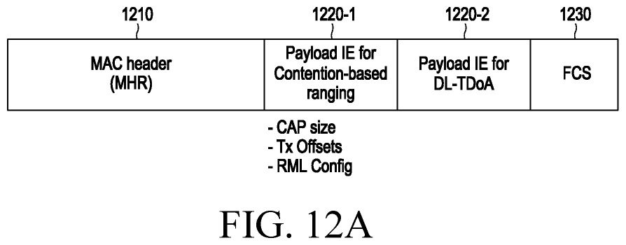

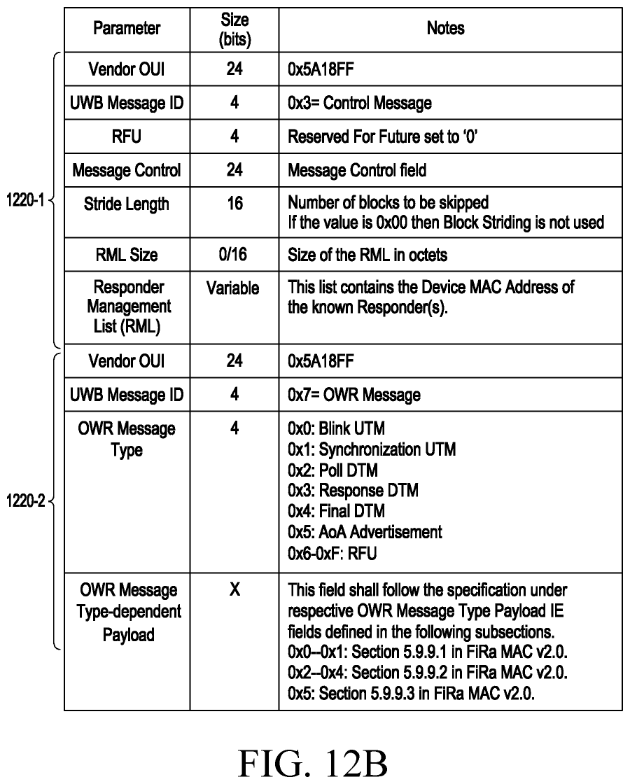

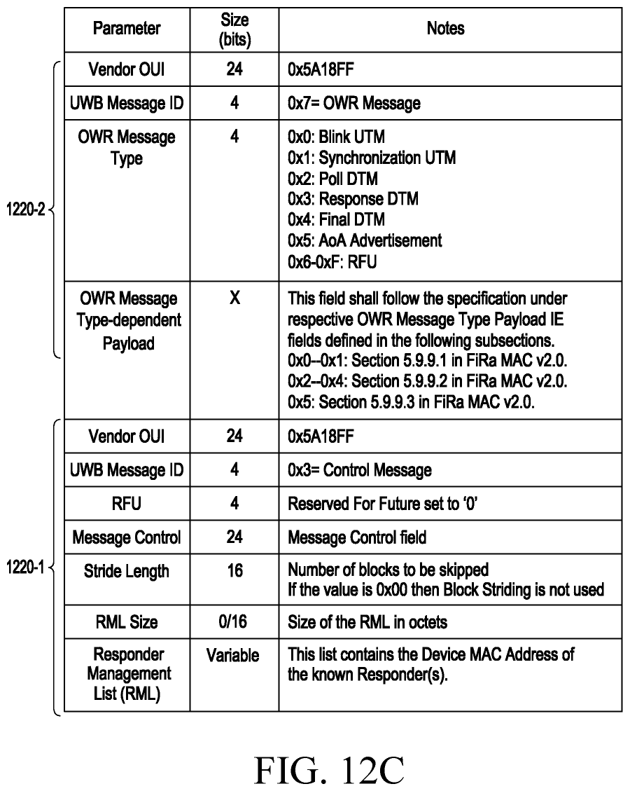

FIG. 12A illustrates a structure of a UWB message according to an embodiment of the disclosure.

In the embodiment of FIG. 12A, a UWB message may be an example of the UWB messages used in the ranging procedures of FIG. 10 and FIG. 11. For example, the UWB message of FIG. 12A may be an example of the UWB message (e.g., one of the first to fourth UWB messages) used in the ranging procedure of FIGS. 10 and 11.

Referring to FIG. 12A, the UWB message includes a MAC header 1210, a MAC payload including a payload IE 1220-1 for contention-based ranging and a payload IE 1220-2 for DL-TDoA, and a MAC footer 1230 including an FCS.

In an embodiment, the MAC header 1210 may include all or some of the fields included in the MAC header of FIG. 4.

In an embodiment, the payload IE 1220-1 for contention-based ranging may include data of a control message for contention-based ranging. As an embodiment, the control message for contention-based ranging may include information indicating a CAP size, information on a transmission (Tx) offset, and/or responder management list (RML)-related configuration information.

In an embodiment, the payload IE 1220-2 for DL-TDoA may include all or some of fields included in any one of a payload IE of a poll DTM, a payload IE of a responder DTM, or a payload IE of a final DTM.

FIG. 12B illustrates a payload structure of the UWB message according to an embodiment of the disclosure.

In an embodiment of FIG. 12B, a payload of the UWB message may be an example of the payload (MAC payload) of the UWB message of FIG. 12A.

Referring to FIG. 12B, the UWB message (or the payload of the UWB message) may include the payload IE 1220-1 for contention-based ranging and the payload IE 1220-2 for DL-TDoA. The payload IE 1220-1 for contention-based ranging may be an example of the payload IE 1120-1 for contention-based ranging of FIG. 11, and the payload IE 1220-2 for DL-TDoA may be an example of the payload IE 1120-2 for DL-TDoA of FIG. 11.

In the embodiment of FIG. 12B, the payload IE 1220-1 for contention-based ranging may precede the payload IE 1220-2 for DL-TDoA.

### [Payload IE 1220-1 for Contention-Based Ranging]

The payload IE 1220-1 for contention-based ranging may include a control message for contention-based ranging. As an embodiment, the control message for contention-based ranging may be control message type 2.

In an embodiment, the payload IE 1220-1 for contention-based ranging (or the control message for contention-based ranging) may include a UWB message ID field, a message control field, a striding length field, an RML size field, and/or or an RML field.

The UWB message ID field may identify the UWB message. For the payload IE 1220-1 for contention-based ranging, the UWB ID field may be configured to be a value designating the control message.

The message control field may configure parameters used for contention-based ranging with responders participating in contention-based ranging. As an embodiment, the message control field may include CAP size information (field) designating a size of a contention period in a unit of ranging slots used in a CAP. Via the CAP size information, the number of ranging slots in which a UE may make a contention-based response may be designated. Table 8 below may illustrate an example of the message control field.

TABLE 8

| | Size | |
|---|---|---|
| Parameter | (bits) | Notes |
| CAP Size | 8 | Size of the contention period in ranging slots used in the CAP |
| Measurement | 1 | 0: MRP is not present |
| Report Phase | | 1. MRP is present |
| Control | | This is applicable only if DS-TWR ranging round is used in Contention-based |
| | | ranging |
| RFU | 1 | RFU |
| Number of Tx | 2 | Number of Tx offsets within the ranging slot available for transmission of the |
| Offsets | | message from the Responder |
| | | 0b00 -No Tx offset allowed |
| | | 0b01 - 2 Tx offsets |
| | | 0b10 - 4 Tx offsets |
| | | 0b11 - 8 Tx offsets |
| Hopping Mode | 1 | 0: The same ranging round will be used for the next ranging block |
| | | 1: Ranging round which follows the hopping sequence will be used for the next |
| | | ranging block. |
| Stop Ranging | 1 | 0: Ranging will be continued |
| | | 1: Ranging will be stopped |
| RML Config | 2 | 0b00: Responder Management List is absent. |
| | | 0b01: Responder Management List is present and contains the short MAC address of |
| | | the responder(s). |
| | | 0b10: Responder Management List is present and contains the extended MAC |
| | | address of the responder(s). |
| | | Ob11: RFU |
| Allowed Tx | 8 | Allowed Tx offsets for the Responder to transmit the message |
| Offsets | | Where, |
| | | Bit0 to Bit7 represents the allowed Tx offsets within a ranging slot |
| | | Tx Offset bit <n> = n * ranging slot duration/Number of Tx Offsets |
| | | Bit <n> value set to 0 indicates that the Tx Offset <n> is not allowed to be used in |
| | | the CAP slot for transmission of frame. |
| | | Bit <n> valde set to 1 indicates that the Tx Offset <n> is allowed to be used in the |
| | | CAP slot for transmission of frame. |
| | | This field is not applicable when Number of Tx Offsets is set to value “0b00”. |
| | | This bitmap shall be consistent with Number of Tx Offsets: |
| | | if Number of Tx Offset = 0b01, only Bit <0> and Bit <1> are relevant |
| | | if Number of Tx Offsets = 0b10, only Bit <0> to Bit <3> are relevant. |

The striding length field may designate the number of ranging blocks to be skipped.

The RML size field may designate an RML size.

The RML field may be a list including device MAC addresses of known responder(s). The RML field may include the number of RML elements corresponding to the RML size. Table 9 below illustrates an example of the RML elements included in the RML field. Referring to Table 9, each RML element may designate a MAC address of a corresponding responder.

TABLE 9

| | Size | |
|---|---|---|
| Parameter | (octets) | Notes |
| Responder MAC | 2/8 | Device MAC Address |
| Address | | of Responder |

For example, when a two-byte short MAC address is used and 5 responders are managed by an RML, a value of the RML size field may be configured to be 5, and the RML field may be data with a length of 10 bytes.

As illustrated in FIGS. 10 and 11, a CAP in which the UE may perform contention-based response may be configured via the CAP size field and the RML size field included in the payload IE 1220-1 for contention-based ranging. In addition, when control messages for contention-based ranging are synchronized with each other, the value of the CAP size field and the value of the RML size field may be configured so that all the synchronized control messages enable configuration of the same CAP. In this case, the value of the CAP size field may be the same in all the synchronized control messages.

### [Payload IE 1220-2 for DL-TDoA]

In an embodiment, the payload IE 1220-2 for DL-TDoA may include a UWB message ID field, an OWR message type field, and an OWR message type-dependent payload field.

The UWB message ID field may identify the UWB message. For the payload IE 1220-2 for DL-TDoA, the UWB ID field may be configured to be a value designating an OWR message.

The OWR message type field may designate an OWR message type. For the payload IE 1220-2 for DL-TDoA, the OWR message type field may be configured to be a value designating one of a poll DTM, a response DTM or a final DTM.

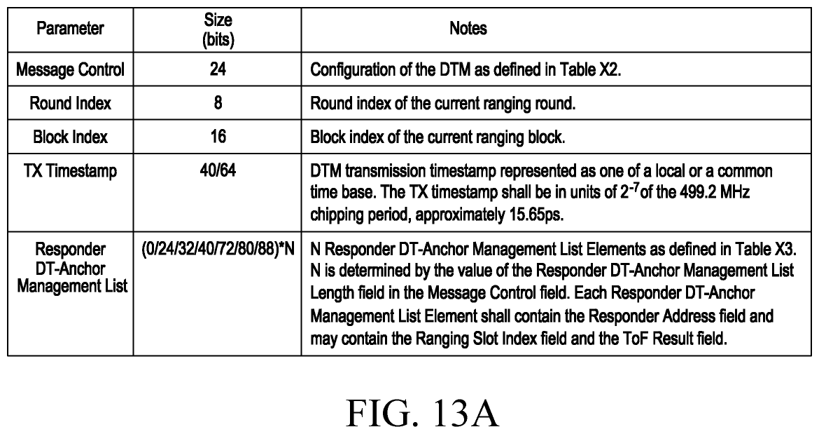

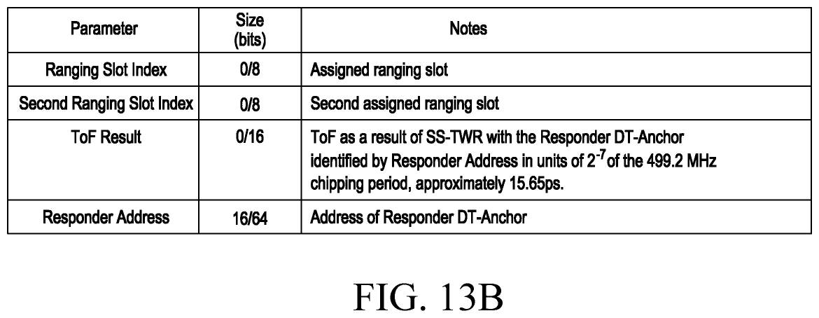

The OWR message type-dependent payload field may include payload data according to the value designated by the OWR message type field. When the value configured in the OWR message type field designates a poll DTM, a response DTM, or a final DTM, that is, when a DTM is designated, an example of the OWR message type-dependent payload field is described below with reference to FIGS. 13A and 13B.

FIG. 12C illustrates a payload structure of a UWB message according to an embodiment of the disclosure.

In the embodiment of FIG. 12C, a payload of the UWB message may be an example of the payload (MAC payload) of the UWB message of FIG. 12A.

Referring to FIG. 12C, the UWB message (or the payload of the UWB message) may include the payload IE 1220-1 for contention-based ranging and the payload IE 1220-2 for DL-TDoA. The payload IE 1220-1 for contention-based ranging may be an example of the payload IE 1120-1 for contention-based ranging of FIG. 11, and the payload IE 1220-2 for DL-TDoA may be an example of the payload IE 1120-2 for DL-TDoA of FIG. 11.

Unlike the embodiment of FIG. 12B, in the embodiment of FIG. 12C, the payload IE 1220-1 for contention-based ranging may follow the payload IE 1220-2 for DL-TDoA.

Each field (information) included in the payload IE 1220-1 for contention-based ranging in the embodiment of FIG. 12C is the same as each field (information) included in the payload IE 1220-1 for contention-based ranging in FIG. 12B. Accordingly, reference may be made to the description of FIG. 12B.

In addition, each field (information) included in the payload IE 1220-2 for DL-TDoA of the embodiment of FIG. 12C is the same as each field (information) included in the payload IE 1220-2 for DL-TDoA of FIG. 12B. Accordingly, reference may be made to the description of FIG. 12B.

FIG. 13A and FIG. 13B illustrate an example of an OWR message type-dependent payload field included in a UWB message, according to an embodiment of the disclosure.

In the embodiment of FIG. 13, an OWR message type-dependent payload field of a UWB message may be an example of the OWR message type-dependent payload field of the payload IE 1220-2 for DL-TDoA of FIGS. 12A and 12B.

Referring to FIG. 13A, when a value configured in the OWR message type field designates a poll DTM, a response DTM, or a final DTM, the OWR message type-dependent payload field may include a message control field, a round index field, a block index field, a transmission (Tx) timestamp field, and/or a responder DT-anchor management list field.

The message control field may include a configuration of a corresponding DTM. The round index field may designate a round index of a current ranging round.

The block index field may designate a block index of the current ranging block.

The transmission timestamp field may designate a transmission timestamp of the DTM, which is expressed as either a local or common time base.

The responder DT-anchor management list field may include N responder DT-anchor management list elements.

N may be determined by a value of the responder DT-anchor management list length field in the message control field. Each responder DT-anchor management list element may include a responder address field, a ranging slot index field, a second ranging slot index field, and/or a ToF result field for a corresponding responder DT-anchor. An example of the responder DT-anchor management list element is described below with reference to FIG. 13B.

Referring to FIG. 13B, the responder DT-anchor management list element may include a responder address field, a ranging slot index field, a second ranging slot index field, and/or a ToF result field.

The responder address field may designate an address (e.g., MAC address) of a responder DT-anchor (responder anchor).

The ranging slot index field may designate a ranging slot allocated to the responder DT-anchor (responder anchor) identified by the responder address field. As an embodiment, the ranging slot designated by the ranging slot index field may be used for the responder DT-anchor to transmit a first response message (e.g., the second UWB message of FIG. 10/11) in response to an initiation message (e.g., the first UWB message of FIG. 10/11) transmitted by an initiator DT-anchor (initiator anchor). In other words, the ranging slot index field may be used for the responder anchor to transmit the first response message.

The second ranging slot index field may designate a second ranging slot allocated to the responder DT-anchor (responder anchor) identified by the responder address field. As an embodiment, the ranging slot designated by the second ranging slot index field may be used for the responder DT-anchor to transmit a second response message (e.g., the fourth UWB message of FIG. 10/11) in response to a final message (e.g., the third UWB message of FIG. 10/11) transmitted by the initiator DT-anchor (initiator anchor). In other words, the second ranging slot index field may be used for the responder anchor to transmit the second response message.

The ToF result field may include a ToF as a result of SS-TWR with the responder DT-anchor identified by the responder address field.

In an embodiment, the OWR message type-dependent payload field may further include a clock frequency offset (CFO) field designating a CFO with respect to the initiator anchor and/or a reply time field (e.g., a reply time list field or a responder reply time field) including information on at least one reply time.

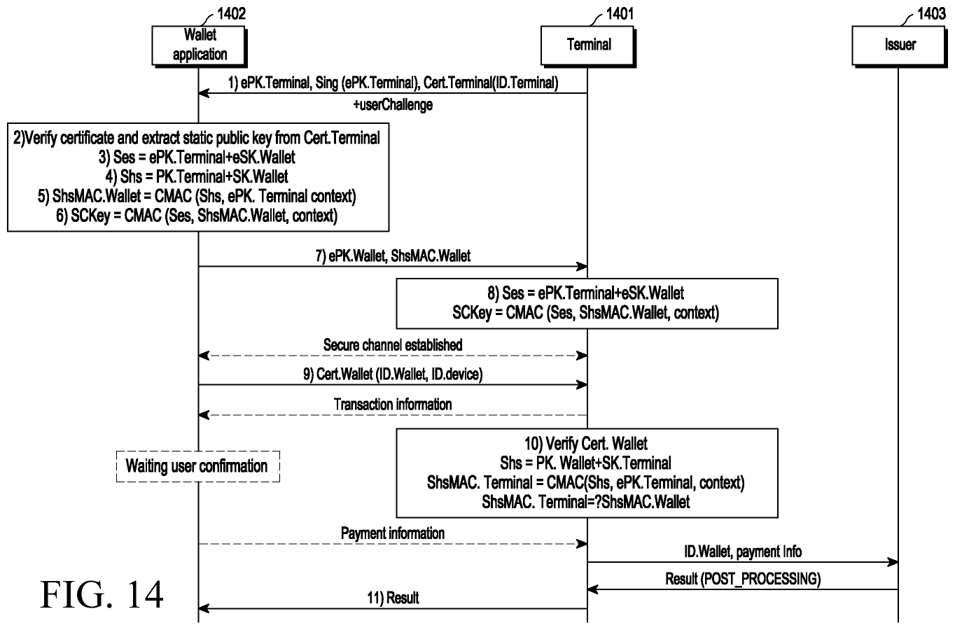

FIG. 14 illustrates a method of generating a secure channel according to an embodiment of the disclosure.

A secure channel may be established between a payment terminal 1401 (e.g., the payment terminal 901 of FIG. 9) and a UE 1402 (e.g., the UE 902 of FIG. 9) (or a payment application (wallet application) of the UE). For example, the secure channel may be used to establish an encryption-supported communication channel between the payment terminal 1401 and the payment application of the UE 1402.

The secure channel may be used for the payment terminal 1401 and the UE 1402 to exchange a payment transaction on UWB in-band.

Referring to FIG. 14, a procedure of establishing a secure channel may include operations 1 to 11. However, according to an embodiment, some operations may be omitted, additional operations may be further performed, or operations may be performed in a sequence different from that illustrated herein.

In operation 1, the payment terminal 1401 may generate an ephemeral key of the payment terminal. The ephemeral key of the payment terminal may be expressed as “ePK.Terminal”.

In addition, the payment terminal 1401 may sign the generated “ePK.Terminal” by using a privacy key. As an example, the privacy key may be a static privacy key. The signed ephemeral key of the payment terminal may be expressed as “Sign (ePK.Terminal)”.

In addition, the payment terminal 1401 may use the privacy key to perform signing by combining the generated ePK.Terminal and user random challenge information transferred by the UE in phase 1022. For example, signing may be performed on a character string (ePK.Terminal|UserChallenge) that connects ePK.Terminal and a user random challenge. A user random challenge value is a value that is randomly generated and transferred by the UE in phase 1022, so that, by signing a character string including the user random challenge value, the payment terminal 1401 may hold a privacy key corresponding to a public key included in a certificate of the payment terminal, and this may be used as a method for proving that the payment terminal 1401 is able to perform signing in real time.

In addition, the payment terminal 1401 may transmit, to the UE 1402, “ePK.Terminal”, “Sign (ePK.Terminal)”, and the certificate of the payment terminal, which includes an ID of the payment terminal, together with the random challenge information of the UE, which is used for mutual authentication. The certificate of the payment terminal including the ID of the payment terminal may be expressed as “Cert.Terminal(ID.Terminal). The random challenge information of the UE may be expressed as “userChallenge”.

In operation 2, the UE 1402 (or payment application) may verify the certificate (Cert.Terminal) of the payment terminal, and extract the public key of the payment terminal from the certificate. As an example, the public key may be a static public key. The public key of the payment terminal may be referred to as “PK.Ternimal”.

In operation 3, the UE 1402 (or payment application) may derive a shared ephemeral secret (Ses). As an example, the UE 1402 (or payment application) may generate the Ses by using “ePK.Terminal” and an ephemeral private key of the payment application. The ephemeral key of the payment application may be expressed as “eSK.Wallet”. As an example, the Ses may include “ePK.Terminal” and “eSK.Wallet”. In this case, the UE 1402 may already have a certificate chain, which is used to verify the certificate of the payment terminal, in the payment application or payment applet. Alternatively, the UE 1402 may perform verification by downloading a certificate chain, which may be used to verify the certificate, via a certificate database searchable using the payment terminal ID. The certificate chain may be a certificate chain including certificates issued by a certificate issuer trusted by the UE 1402.

In operation 4, the UE 1402 (or payment application) may derive a shared static secret (Shs). The UE 1402 (or payment application) may generate the Shs by using “PK.Ternimal” and the static privacy key of the payment application. The static privacy key of the payment application may be expressed as “SK.Wallet”. As an example, the Shs may include “PK.Terminal” and “SK.Wallet”.

In operation 5, the UE 1402 (or payment application) may derive a message authentication code (MAC) from “Shs” and “ePK.Terminal”. The message authentication code may be expressed as “ShsMAC.Wallet”. As an example, the message authentication code mmm be generated based on a cipher-based message authentication code (CMAC) algorithm. For example, the message authentication code may be generated based on “CMAC (Shs, ePK.Terminal, context)”.

In operation 6, the UE 1402 (or payment application) may generate secure channel keys for encryption and authentication, respectively. That is, a secure channel key for encryption and a secure channel key for authentication may be separately generated. The UE 1402 (or payment application) may generate the secure channel keys for encryption and authentication from “Ses” and “ShsMAC.Wallet”. The secure channel keys may be expressed as “SCkey”. As an example, the secure channel keys may be generated based on the CMAC algorithm. For example, the secure channel keys may be generated based on “CMAC (Ses, ShsMAC.Wallet, Context)”.

In operation 7, the UE 1402 (or payment application) may transmit “ePK.Wallet” and “ShsMAC.Wallet” to the payment terminal 1401.

In operation 8, the payment terminal 1401 may derive the Ses from the received “ePK.Wallet”. As an example, the Ses may include “ePK.Terminal” and “eSK.Wallet”.

In addition, the payment terminal 1401 may derive the secure keys for encryption and authentication. As an example, the secure channel keys may be generated based on the CMAC algorithm. For example, the secure channel keys may be generated based on “CMAC (Ses, ShsMAC.Wallet, Context)”.

Accordingly, a secure channel may be established. In subsequent procedures, the UE 1402 and the payment terminal 1401 may transmit data via the established secure channel.

The secure channel established by performing up to operation 8 may be a half-authenticated channel. That is, only the payment terminal 1401 may have been authenticated for the secure channel. In order for the secure channel to be fully authenticated, that is, in order for the UE 1402 (or payment application) to be authenticated, subsequent operations 9 and 10 may be further performed.

In addition, the secure channel may be a half-trusted channel in which the certificate is protected with the ephemeral key.

In operation 9, the UE 1402 (or payment application) may transmit the certificate (“Cert. Wallet”) of the payment application, which includes the ID of the payment application and/or an ID of the UE, to the payment terminal 1401 via the established secure channel. “Cert. Wallet” includes personal information, such as the ID of the payment application and the ID of the UE, so that, in order to protect the personal information, “Cert. Wallet” may be transmitted via the established secure channel, without being transmitted before the secure channel is established.

In operation 10, the payment terminal 1401 may verify “Cert.Wallet”. The payment terminal 1401 may extract the static public key from “Cert. Wallet”. The payment terminal 1401 may derive “Shs”, derive “ShsMAC.Wallet” from the “Shs”, and compare the self-derived “ShsMAC.Wallet” with the “ShsMAC.Wallet” received via operation 7.

As an example, “ShsMAC.Wallet” may be generated based on the cipher-based message authentication code (CMAC) algorithm. For example, “ShsMAC.Wallet” may be generated based on “CMAC (Shs, ePK.Terminal, context)”.

If the two “ShsMAC.Wallet” do not have the same value, the payment terminal 1401 may drop all previous messages and terminate the session. If the two “ShsMAC.Wallet” have the same value, authentication for the UE (or payment application) may be completed.

In an embodiment, the payment terminal 1401 may transmit transaction information after operation 9. For example, the payment terminal 1401 may transmit transaction information after operation 9 and before operation 10. For example, the payment terminal 1401 may transmit transaction information after operation 10. In an embodiment, the transaction information may include information on a merchant name associated with the payment terminal 1401 and/or amount information.

In an embodiment, after receiving the transaction information, the UE 1402 (or payment application) may transmit payment information to the payment terminal 1401. For example, the UE 1402 (or payment application) may transmit the payment information after operation 10. As an embodiment, the payment information may include information on card numbers (or token).

In operation 11, the payment terminal 1401 may transmit a result to the UE 1402 (or payment application). As an example, the result may include information indicating that the authentication of FIG. 10 has failed, information indicating that the authentication of FIG. 10 has failed and thus the final payment is not approved, information indicating that the authentication of FIG. 10 has succeeded, or information indicating that the authentication of FIG. 10 has succeeded and thus the final payment has been approved.

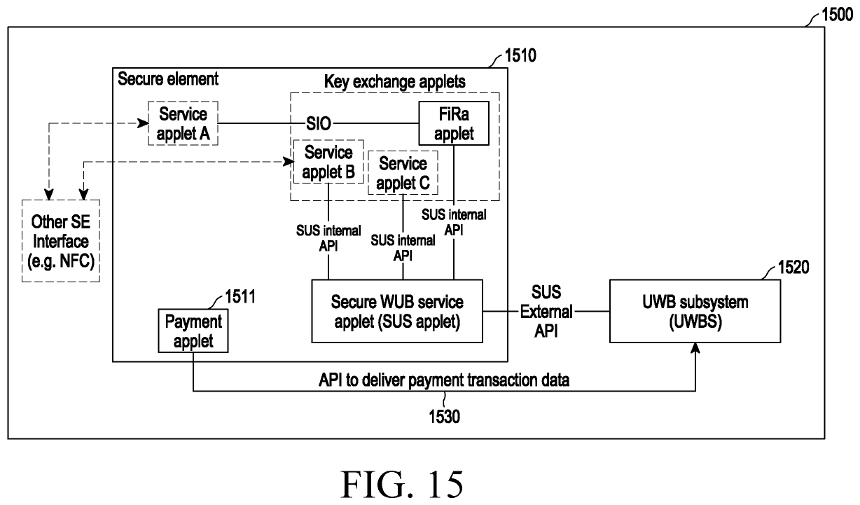

FIG. 15 illustrates a UWB device including a secure component according to an embodiment of the disclosure.

The UWB device of FIG. 15 may be, for example, an example of the UWB device of FIG. 2B.

Referring to FIG. 15, the UWB device 1500 may include a secure element 1510. The secure element 1510 may be an example of the secure element 214b-1 of FIG. 2B.

The secure element 1510 may include at least one applet. For example, a payment applet 1511 for a UWB-based payment service (e.g., the payment service of FIG. 9) may be included.

As an embodiment, the payment applet 1511 may include data/information for a UWB-based payment. For example, the payment applet 1511 may include data/information for a payment transaction (e.g., payment information or transaction information).

As an embodiment, data of the applet may be transmitted via an application protocol data unit (APDU). For example, data of the payment applet 1511 may be transmitted by being included in an APDU referred to as a payment transaction data APDU.

As an example, the payment applet 1511 may transmit data (or payment transaction data APDU) of the payment applet 1511 to a UWBS 1520 via an API defined/configured between the UWBS 1520 and the payment applet 1511.

For example, as illustrated in FIG. 15, an SUS internal API that is an interface between an applet and an SUS applet, and an SUS external API that is an interface between the SUS applet and the USBS 1520 may only be used to transmit data, such as a ranging data set (RDS) used to generate a UWB session, such as a UWB session key and a UWB session ID, and may not be used to transmit data of the applet, such as the payment applet 1511. In such a scenario, data of the payment applet 1511 cannot be transmitted to the UWBS 1520 via the SUS internal API and the SUS external API.

Therefore, a separate API needs to be defined/configured between the UWBS 1520 and the payment applet 1511, and the payment applet 1511 may transmit data of the payment applet 1511 to the UWBS 1520 via the API defined/configured between the UWBS 1520 and the payment applet 1511.

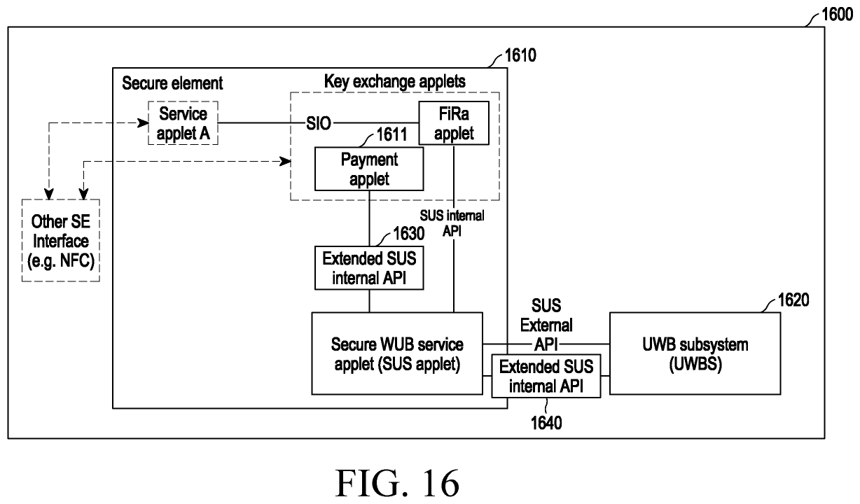

FIG. 16 illustrates a UWB device including a secure component according to an embodiment of the disclosure.

The UWB device of FIG. 16 may be, for example, an example of the UWB device of FIG. 2B.

Referring to FIG. 16, the UWB device 1600 may include a secure element 1610. The secure element 1610 may be an example of the secure element 214b-1 of FIG. 2B.

The secure element 1610 may include at least one applet. For example, a payment applet 1611 for a UWB-based payment service (e.g., the payment service of FIG. 9) may be included.

As an embodiment, the payment applet 1611 may include data/information for a UWB-based payment. For example, the payment applet 1611 may include data/information for a payment transaction (e.g., payment information or transaction information).

As an embodiment, data of the applet may be transmitted via an application protocol data unit (APDU). For example, data of the payment applet 1611 may be transmitted by being included in an APDU referred to as a payment transaction data APDU.

As an example, the payment applet 1611 may transmit data (or payment transaction data APDU) of the payment applet 1611 to a UWBS 1620 via an extended SUS internal API 1630 and an extended SUS external API 1640.

In the embodiment of FIG. 16, unlike the embodiment of FIG. 15, the SUS internal API 1630 and the SUS external API 1640 may be extended and used to transmit not only an RDS but also data of the payment applet 1611 (or payment transaction data APDU).

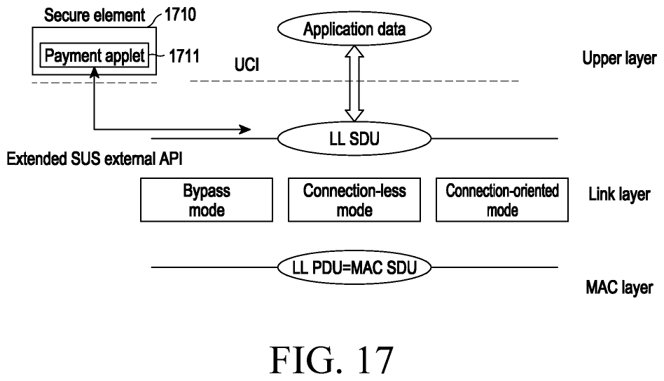

FIG. 17 illustrates a method of transferring data in a secure component of a UWB device to a UWBS according to an embodiment of the disclosure.

In the embodiment of FIG. 17, the UWB device of FIG. 17 may be, for example, an example of the UWB device of FIG. 2B.

Referring to FIG. 17, the UWB device may include a secure element 1710. The secure element 1710 may be an example of the secure element 214b-1 of FIG. 2B.

The secure element 1710 may include at least one applet. For example, the secure element 1710 may include a FiRa applet that provides a ranging data set (RDS) for secure ranging. In addition, a payment applet 1711 for a UWB-based payment service (e.g., the payment service of FIG. 9) may be included.

As an embodiment, the payment applet 1711 may interface with a UWBS via an extended SUS external API (e.g., the extended SUS external API 1640 of FIG. 16). The payment applet 1711 may also interface with the UWBS via the extended SUS external API 1640 via the secure UWB service applet (SUS applet) via the extended SUS internal API 1630 according to FIG. 16.

Data (or payment transaction data APDU) of the payment applet 1711 transferred to the UWBS via the extended SUS external API may be transmitted to a MAC layer via a link layer (LL).

The data (or payment transaction data APDU) of the payment applet 1711 may be processed in a connection-oriented mode according to a preconfigured transmission mode (e.g., connection-oriented mode) of the link layer, and transmitted to the MAC layer. The payment applet 1711 may transfer or process the data according to a payment transaction protocol defined by the EMVCo. For data transmitted and received via the payment applet 1711, a data transmission technique based on the connection-oriented mode of the link layer (LL) may be used. According to the transmission technique based on the connection-oriented mode, the payment applet 1711 may transmit payment data by specifying a destination as a payment applet of a counterpart device side with which communication is performed for payment. In addition, via the data transmission technique based on the connection-oriented mode, functions, such as time out, retransmission, and payment data fragmentation/reassembly, may be performed.

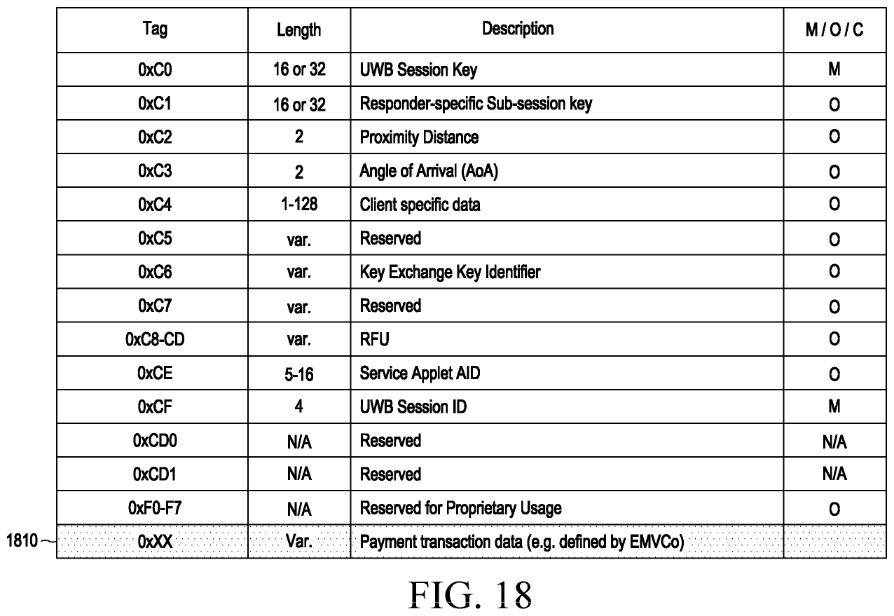

FIG. 18 illustrates components of an RDS supported in an SUS API according to an embodiment of the disclosure.

FIG. 18 is, specifically, some examples of a ranging data set (RDS) configuration provided in an SUS internal API. The SUS internal API is the API between the key exchange applet in the secure element 1610 and the SUS applet. The key exchange applet configures the ranging data set (RDS) in a tag length value (TLV) format as shown in FIG. 18, and transfers the same to the SUS applet via the SUS internal API. Referring to FIG. 18, a partial embodiment is illustrated, in which an APDU (payment transaction data APDU) is included as one of the components of the RDS supported by the SUS API (SUS internal API and/or SUS external API) for transferring of payment transaction data. In the embodiment, the payment transaction data, which is payment-related data defined by the EMVCo, may be identified by a tag number of 0xXX and transferred as one of the RDS components. The payment transaction data may be, according to FIG. 18, transferred from the payment applet to the SUS applet by an RDS transmission scheme supported by the extended SUS internal API, and transferred to the UWBS via the extended SUS external API.

Although not illustrated in the drawing, the payment transaction data may also be transferred via a separate APDU. In this case, the extended SUS internal API may be extended to transfer a data APDU including the payment transaction data. In addition, the extended SUS external API may be extended to transfer a data APDU including the payment transaction data. In this case, APDU commands used to transfer the payment transaction data APDU may be GET DATA and STORE DATA defined in the GlobalPlatform Card Specification.

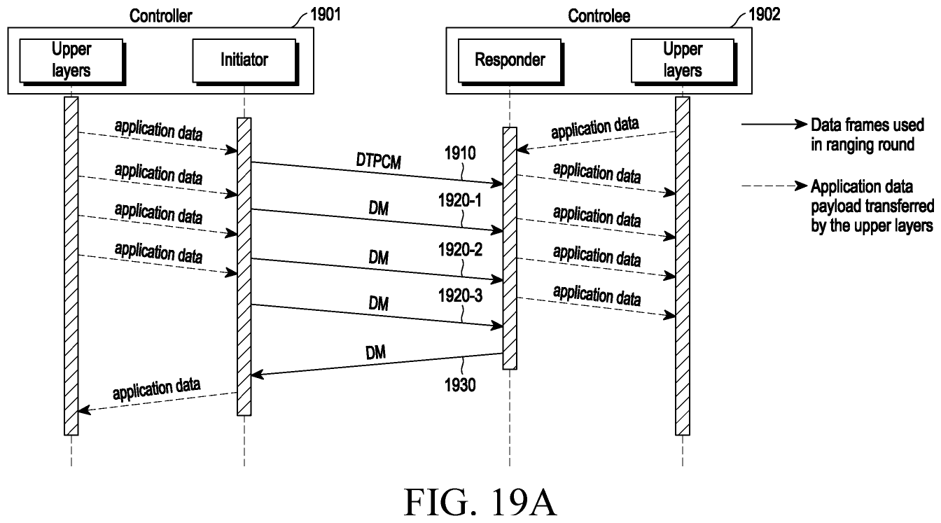

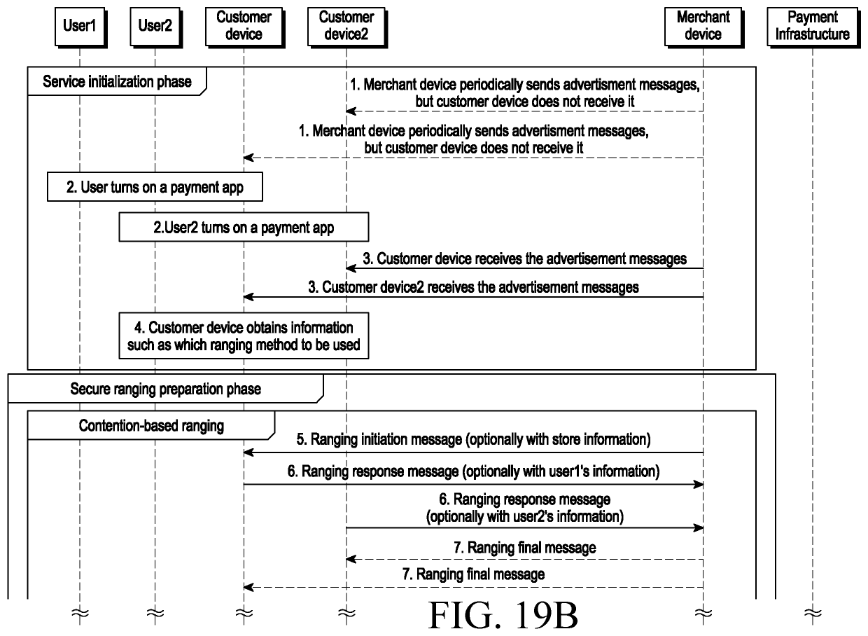

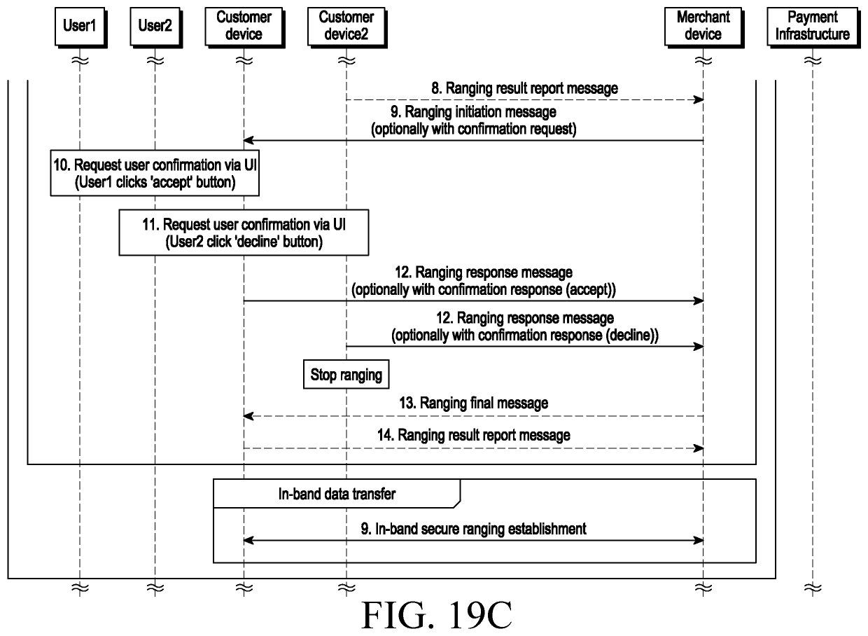

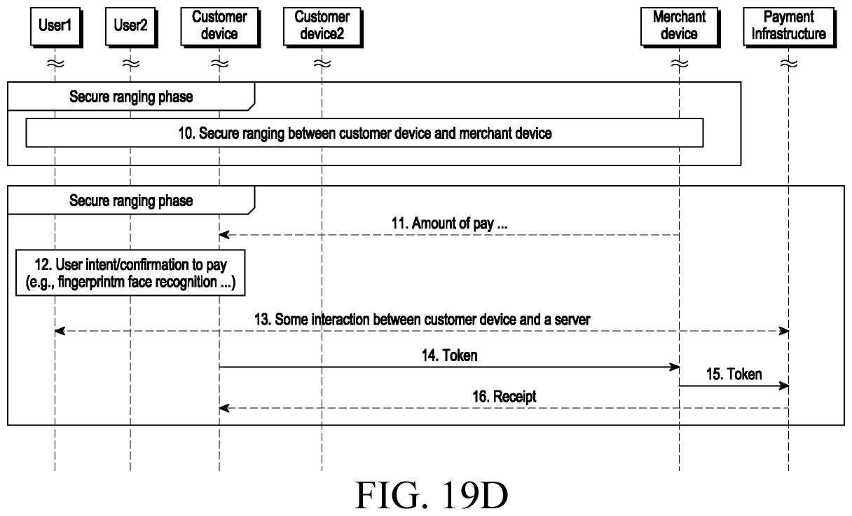

FIG. 19A illustrates a data transmission procedure using UWB according to an embodiment of the disclosure.

The data transmission procedure of FIG. 19A may be a procedure for transmitting a data message (DM) (data frame) rather than a ranging message (RFRAME). As an example, the data message may include, for example, transaction information and/or payment information for a UWB-based payment service.

In the embodiment of FIG. 19A, it is assumed that a first UWB device 1901 is configured to serve as an initiator device and a device type of controller, and a second UWB device 1902 is configured to serve as a responder device and a device type of controlee. According to an embodiment, the first UWB device 1901 may be the payment terminal 901 or the UE 902.

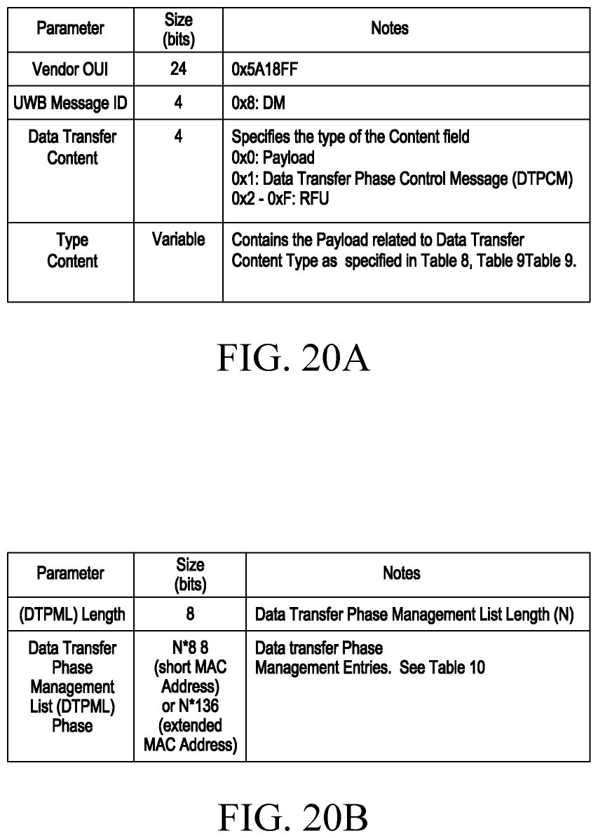

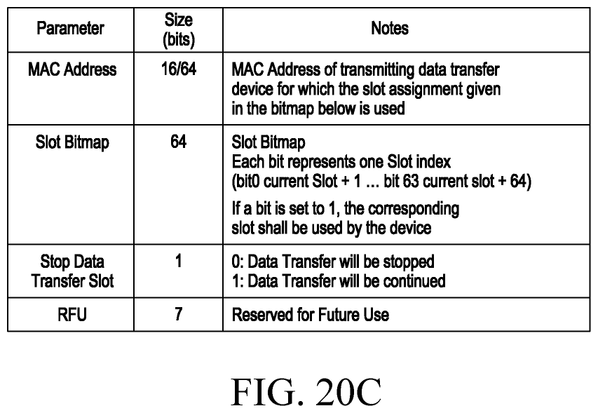

Referring to FIG. 19A, the first UWB device 1901 may transmit a data transfer phase control message (DTPCM) 1910 for configuration of a data transfer phase. According to an embodiment, the payment terminal 901 may be the first UWB device 1901 and transfer the data transfer phase control message (DPTCM) to the UE 902 which is the second UWB device 1902, and the UE 902 may transfer user information 903 to the payment terminal 901, based on scheduling information of the data transfer phase control message (DTPCM). The UE 901 may identify, based on the data transfer phase control message (DTPCM), a ranging slot for receiving the payment terminal information 920 or payment information 940 transmitted by the payment terminal 901. As an example, the first UWB device 1901 may configure the DTPCM, based on application data transferred from upper layers. An example of the DTPCM 1910 is described below with reference to FIGS. 20A to 20C.

The first UWB device 1901 may transmit at least one DM. For example, as illustrated, the first UWB device 1901 may transmit three DMs 1920-1, 1920-2, and 1920-3. As an embodiment, the first UWB device 1901 may transmit the DMs in ranging slots allocated by the DTPCM 1910. As an example, the first UWB device 1901 may configure the DMs, based on the application data transferred from the upper layers. As an embodiment, the second UWB device 1902 may transfer, to upper layers, the application data in the DMs received from the first UWB device 1901.

The second UWB device 1902 may transmit at least one DM. For example, as illustrated, the second UWB device 1902 may transmit one DM 1930. As an embodiment, the second UWB device 1902 may transmit the DM in a ranging slot allocated by the DTPCM 1910. As an example, the second UWB device 1902 may configure the DM, based on the application data transferred from the upper layers. As an embodiment, the first UWB device 1901 may transfer, to the upper layers, the application data in the DM received from the second UWB device 1902.

FIG. 19B is a diagram illustrating an embodiment of exchanging data while performing contention-based ranging between a first UWB device (merchant device) and multiple second UWB devices (customer devices).

In FIG. 19B, the first UWB device may correspond to a merchant device or a payment terminal. According to phase 5 of the drawing, the payment terminal may transfer a contention-based ranging initiation message to nearby UEs. The contention-based ranging initiation message may include a contention-based ranging control message. The contention-based ranging initiation message may be combined with a DM payload IE and transmitted. Phase 5 may be a partial embodiment of the payment terminal information transmission phase 920 of FIG. 9.

In phase 6 of FIG. 19B, a UE may transfer a contention-based ranging response message to the payment terminal. The UE may combine the contention-based ranging response message with a DM payload IE, and transmit the same. In this case, user information in a content field of the DM payload IE combined with the contention-based ranging response message may be transferred. Phase 6 may be a partial embodiment of the user information transmission phase 930 of FIG. 9.

Phases 7 and 8 of FIG. 19B may be additionally performed when the contention-based ranging is double-sided two-way ranging.

As a result of phase 6 or phase 8 of FIG. 19B, the payment terminal may discover nearby UEs. In this case, the payment terminal may measure distances between the payment terminal itself and the discovered nearby UEs. In addition, the payment terminal may additionally acquire user information when the discovered nearby UEs transmit response messages including the user information in phase 6.

In phase 9 of FIG. 19C, the payment terminal may select one of the discovered UEs and transmit a connection request message. The connection request message may be included in a payload of a DM payload IE combined with a contention-based initiation message, so as to be transferred. The connection request message may be configured according to a TLV (type-length value or tag-length value) structure. The connection request message may include data in the TLV format having a type or tag value indicating a connection request.

TABLE 10

| | Value | |
|---|---|---|
| Message | of Type | Description |
| Request to | 0 × XX | The message sent by the Merchant |
| connect | | Device when a clerk selects the |
| | | Customer Device to proceed a |
| | | payment. This message is only |
| | | sent by the Merchant Device. |
| posChallenge | 0 × XX | Random challenge value of |
| | | Merchant Device or PoS terminal. |

When the payment terminal transmits the connection request message, a random challenge (posChallenge) of the payment terminal may be additionally included and transferred. In this case, the payment terminal may connect the data in the TLV format corresponding to the connection request and the data in the TLV format corresponding to the random challenge (posChallenge) of the payment terminal, and include the connected data in the payload of the DM payload IE so as to transmit the same to the UE desired to be connected.

In phase 12 of FIG. 19C, the UE having received the connection request message may add a connection approval message or a connection rejection message to a payload of a DM payload IE combined with a contention-based ranging response message, and transfer the same to the payment terminal. The connection approval message or the connection rejection message may be configured according to the TLV (type-length value or tag-length value) structure. The connection approval message and the connection rejection message may include data in the TLV format having a type or tag value indicating connection approval and connection rejection, respectively.

TABLE 11

| | Value | |
|---|---|---|
| Message | of Type | Description |
| Accept to | 0 × XX | The message sent by the Customer |
| connect | | Device as a response of ‘Request |
| | | to connect’ when the user confirms |
| | | to connect with the Merchant |
| | | Device which sent the ‘Request to |
| | | connect’. |
| | | This message is only sent by the |
| | | Customer Device. |
| Reject to | 0 × XX | The message sent by the Customer |
| connect | | Device as a response of ‘Request |
| | | to connect’ when the user confirms |
| | | to connect with the Merchant |
| | | Device which sent the ‘Request to |
| | | connect’. |
| | | This message is only sent by the |
| | | Customer Device. |
| UserChallenge | 0 × XX | Random challenge value of User |
| | | Device. |

When approving the connection, the UE may additionally transmit a user challenge (UserChallenge) value. In this case, the TLV structure indicating connection approval and the TLV structure indicating the user challenge may be connected and included in the payload of the DM payload IE, and transmitted from the UE to the payment terminal.

In the phase above, the random challenge (posChallenge) of the payment terminal and the random challenge (userChallenge) of the UE, which are exchanged between the UE and the payment terminal, may also be used as the random challenges used for mutual authentication performed between the UE and the payment terminal in FIG. 14. In this case, the random challenges may be values used in a secure channel protocol, such as SCP03 and SCP11 of the GlobalPlatform, which is a commonly used security protocol. The payment terminal and the UE may use the random challenge of the payment terminal and the random challenge of the UE, respectively, as parts of data for generating a signature used for mutual authentication, in the payload of the DM payload IE which is combined with the ranging message of the contention-based ranging and transmitted, so as to enhance security.

FIG. 20A illustrates a UWB message for data transmission according to an embodiment of the disclosure.

A UWB message for data transmission of FIG. 20A may be an example of the DM or DTPCM of FIG. 19.

Referring to FIG. 20A, a UWB message (data frame) for data transmission may include a UWB message ID field, a data transfer content type field, and/or a content field. For example, the UWB message (data frame) for data transmission may have a payload IE including a UWB message ID field, a data transfer content type field, and/or a content field.

If the UWB message is a DM or a DTPCM, the UWB ID field may be configured to be a value specifying a data message (DM).

The data transfer content type field may specify a type of the content field. As an example, the data transfer content type field may be configured to be a first value indicating that the type of the content field is a payload type, or a second value indicating that the type of the content field is a DTPCM type. For example, if the UWB message is a DTPCM, the data transfer content type field may be configured to be the second value indicating that the type of the content field is the DTPCM type. In this case, an example of the content field is described below with reference to FIG. 20B and FIG. 20C.

The content field may include a payload (payload data) related to the data transfer content type field.

FIG. 20B and FIG. 20C illustrate examples of the content field of the UWB message for data transmission according to an embodiment of the disclosure.

Referring to FIG. 20B, when the data transfer content type field is configured to be the second value indicating that the type of the content field is the DTPCM type (i.e., when the UWB message is DTPCM), the content field may include a data transfer phase management list (DTPML) length field and/or a DTPML list field.

The DTPML length field may specify a length of a DTPML list field. A DTPML length may be the number of UWB UEs participating in a data transfer session for data transmission. For example, when two devices of a payment terminal and a UE participate in a data transfer session for data transmission, a value of the DTPML length field may be 2.

The DTPML list field may include as many data transfer phase management entries as the number specified by the DTPML length field. An example of a data transfer phase management entry is described below with reference to FIG. 20C.

Referring to FIG. 20C, the data transfer phase management entry may include a MAC address field, a slot bitmap field, and/or a stop data transfer slot field.

The MAC address field may specify a MAC address of a transmitting data transfer device for which slot assignment configured by the slot bitmap field is used.

The slot bitmap field may provide slot allocation for a device identified by the MAC address field. The slot bitmap field may include a slot bitmap. Each bit in the slot bitmap may represent one slot index.

As an example, the slot bitmap field may have a size of 64 bits. In this case, bit 0 represents a slot index corresponding to a current slot+1, . . . , and bit 63 represents a slot index corresponding to the current slot+64.

As an example, when a value of a corresponding bit in the slot bitmap is configured to be 1, this may indicate that a corresponding slot is used by a device identified by the MAC address field. Alternatively, when a value of a corresponding bit in the slot bitmap is configured to be 0, this may indicate that a corresponding slot is not used by a device identified by the MAC address field.

The stop data transfer slot field may be configured to be a first value indicating that data transfer will be stopped or a second value indicating that data transfer will continue.

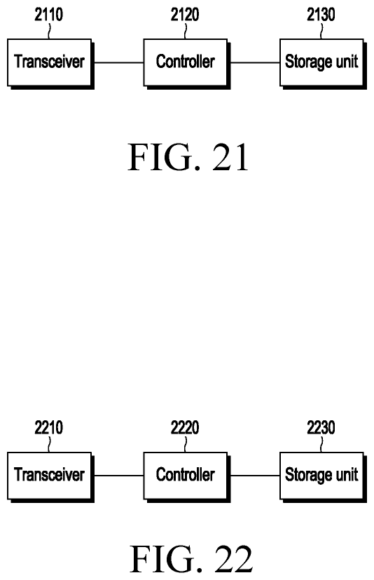

FIG. 21 illustrates a structure of a first UWB device according to an embodiment of the disclosure.

In the embodiment of FIG. 21, a first UWB device may be an electronic device which corresponds to the UWB device of FIG. 1, includes the UWB device, or includes a part of the UWB device. The first UWB device may be, for example, an anchor (e.g., an initiator anchor/responder anchor) for a UWB-based payment service.

Referring to FIG. 21, the first UWB device may include a transceiver 2110, a controller 2120, and a storage unit 2130. In the disclosure, the controller may be defined to be a circuit, an application-specific integrated circuit, or at least one processor.

The transceiver 2110 may transmit a signal to or receive a signal from another entity.

The controller 2120 may control overall operations of the electronic device according to the embodiments proposed in the disclosure. For example, the controller 2120 may control signal flows between respective blocks to perform operations according to the aforementioned flowcharts. Specifically, the controller 2120 may control, for example, the operations (e.g., the operations of the anchor for the UWB-based payment service) of the first UWB device described with reference to FIGS. 1 to 20C and FIG. 23.

The storage unit 2130 may store at least one of information transmitted or received via the transceiver 2110 and information generated via the controller 2120. For example, the storage unit 2130 may store information and data necessary for the method described with reference to FIGS. 1 to 20C and FIG. 23.

FIG. 22 illustrates a structure of a second UWB device according to an embodiment of the disclosure.

In the embodiment of FIG. 22, a second UWB device may be an electronic device which corresponds to the UWB device of FIG. 1, includes the UWB device, or includes a part of the UWB device. The second UWB device may be, for example, a UE for a UWB-based payment service.

Referring to FIG. 22, the second UWB device may include a transceiver 2210, a controller 2220, and a storage unit 2230. In the disclosure, the controller may be defined to be a circuit, an application-specific integrated circuit, or at least one processor.

The transceiver 2210 may transmit a signal to or receive a signal from another entity.

The controller 2220 may control overall operations of the electronic device according to the embodiments proposed in the disclosure. For example, the controller 2220 may control signal flows between respective blocks to perform operations according to the aforementioned flowcharts. Specifically, the controller 2220 may control, for example, the operations (e.g., the operations of the UE for the UWB-based payment service) of the second UWB device described with reference to FIGS. 1 to 20C and FIG. 23.

As an embodiment, the controller 2220 may be configured to receive, from an initiator anchor, a first UWB message for initiating a ranging procedure; receive, from multiple responder anchors, multiple second UWB messages transmitted in response to the first UWB message; receive, from the initiator anchor, a third UWB message transmitted in response to the second UWB messages; and based on the first UWB message, the second UWB messages, and the third UWB message, perform DL-TDoA-based localization.

As an embodiment, the first UWB message may include first information for DL-TDoA and second information for contention-based ranging.

As an embodiment, the first information for DL-TDoA may include a random number generated by the initiator anchor, which is used for mutual authentication.

As an embodiment, the second information for contention-based ranging may include information specifying a size of a contention access period.

As an embodiment, the controller 2220 may select, based on a result of the DL-TDoA-based localization, one anchor among the initiator anchor and the multiple responder anchors.

As an embodiment, the controller 2220 may transmit a ranging response message for SS-TWR to the one anchor, which is selected among the initiator anchor and the multiple responder anchors, in any slot in the contention access period.

As an embodiment, the ranging response message for SS-TWR may include a random number generated by the UWB device, which is used for mutual authentication between the UWB device and the selected anchor.

As an embodiment, in the UWB device, the controller 2220 is further configured to acquire a user's intention by measuring an AoA value of the third UWB message.

The storage unit 2230 may store at least one of information transmitted or received via the transceiver 2210 and information generated via the controller 2220. For example, the storage unit 2230 may store information and data necessary for the method described with reference to FIGS. 1 to 20C and FIG. 23.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-14. (canceled)

15. A method of a customer device supporting an ultra-wideband (UWB) communication, the method comprising:
receiving, from a merchant device supporting the UWB communication, an initiation message for initiating a UWB ranging procedure;
transmitting, to the merchant device, response messages in response to the initiation message;
receiving, from the merchant device, a final message transmitted in response to the response messages; and
transmitting, to the merchant device, a report message in response to the final message,
wherein the initiation message comprises a tag length value (TLV) format message including an identifier of the merchant device and payment-related information.

16. The method of claim 15, wherein the identifier of the merchant device, defined by a payment service provider, indicates information of a store or merchant.

17. The method of claim 15, wherein the payment-related information in the initiation message comprises at least one of a payment protocol, a request to connect, a proprietary range, or a reserved for future usage (RFU).

18. The method of claim 17, wherein:
the payment protocol comprises a list of payment protocol identifiers that the merchant device or the customer device;
the request to connect sent by the merchant device when a clerk selects the customer device; and
the proprietary range comprises a proprietary usage.

19. The method of claim 15, wherein the response messages comprise an identifier of the customer device and payment-related information.

20. The method of claim 19, wherein the payment-related information in the response messages comprises accept to connect, reject to connect, payment protocol, shipping information, proprietary range, or a reserved for future usage (RFU).

21. The method of claim 20, wherein:
the accept to connect sent by the customer device as a response of a request to connect;
the reject to connect sent by the customer device as a response of request to connect;
the payment protocol comprises a list of payment protocol identifiers that the merchant device or the customer device;
the shipping information be used to complete a payment transaction protocol; and
the proprietary range comprises a proprietary usage.

22. A customer device supporting an ultra-wideband (UWB) communication, the customer device comprising:
a transceiver; and
a controller connected to the transceiver, wherein the controller is configured to:
receive, from a merchant device supporting the UWB communication, an initiation message for initiating a UWB ranging procedure;
transmit, to the merchant device, response messages in response to the initiation message;
receive, from the merchant device, a final message transmitted in response to the response messages; and
transmit, to the merchant device, a report message in response to the final message,
wherein the initiation message comprises a tag length value (TLV) format message including an identifier of the merchant device and payment-related information.

23. The customer device of claim 22, wherein the identifier of the merchant device, defined by a payment service provider, indicates information of a store or merchant.

24. The customer device of claim 22, wherein the payment-related information in the initiation message comprises at least one of a payment protocol, a request to connect, a proprietary range, or a reserved for future usage (RFU).

25. A method of a merchant device supporting an ultra-wideband (UWB) communication, the method comprising:
transmitting, to a customer device supporting the UWB communication, an initiation message for initiating a UWB ranging procedure;
receiving, from the customer device, response messages in response to the initiation message;
transmitting, to the customer device, a final message transmitted in response to the response messages; and
receiving, from the customer device, a report message in response to the final message,
wherein the initiation message comprises a tag length value (TLV) format message including an identifier of the merchant device and payment-related information.

26. The method of claim 25, wherein the identifier of the merchant device, defined by a payment service provider, indicates information of a store or merchant.

27. The method of claim 25, wherein the payment-related information in the initiation message comprises at least one of a payment protocol, a request to connect, a proprietary range, or a reserved for future usage (RFU).

28. The method of claim 27, wherein:
the payment protocol comprises a list of payment protocol identifiers that the merchant device or the customer device;
the request to connect sent by the merchant device when a clerk selects the customer device; and
the proprietary range comprises a proprietary usage.

29. The method of claim 25, wherein the response messages comprise an identifier of the customer device and payment-related information.

30. The method of claim 29, wherein the payment-related information in the response messages comprises accept to connect, reject to connect, payment protocol, shipping information, proprietary range, or a reserved for future usage (RFU).

31. The method of claim 30, wherein:
the accept to connect sent by the customer device as a response of a request to connect;
the reject to connect sent by the customer device as a response of request to connect;
the payment protocol comprises a list of payment protocol identifiers that the merchant device or the customer device;
the shipping information be used to complete a payment transaction protocol; and
the proprietary range comprises a proprietary usage.

32. A merchant device supporting an ultra-wideband (UWB) communication, the merchant device comprising:
a transceiver; and
a controller connected to the transceiver, wherein the controller is configured to:
transmit, to a customer device supporting the UWB communication, an initiation message for initiating a UWB ranging procedure;
receive, from the customer device, response messages in response to the initiation message;
transmit, to the customer device, a final message transmitted in response to the response messages; and
receive, from the customer device, a report message in response to the final message,
wherein the initiation message comprises a tag length value (TLV) format message including an identifier of the merchant device and payment-related information.

33. The merchant device of claim 32, wherein the identifier of the merchant device, defined by a payment service provider, indicates information of a store or merchant.

34. The merchant device of claim 32, wherein the payment-related information in the initiation message comprises at least one of a payment protocol, a request to connect, a proprietary range, or a reserved for future usage (RFU).
